(19) United States
(12) Patent Application Publication
(10) Pub. No.: US 2016/0024914 A1
(43) Pub. Date: Jan. 28, 2016

(54) MONITORING MATRIX ACIDIZING OPERATIONS

(71) Applicant: SCHLUMBERGER TECHNOLOGY CORPORATION, Sugar Land, TX (US)

(72) Inventors: Mehdi Ghommem, Bin Ziad (SA); Reza Taherian, Al-Khobar (SA); Stephen John Remane Dyer, Katy, TX (US); Xiangdong Qiu, Al-Khobar (SA)

(21) Appl. No.: 14/550,168

(22) Filed: Nov. 21, 2014

Related U.S. Application Data
(60) Provisional application No. 62/027,958, filed on Jul. 23, 2014.

(51) Int. Cl. E21B 49/00; G01V 1/40; E21B 43/25; G01V 3/20

(52) U.S. Cl. CPC E21B 49/00; G01V 3/20; G01V 1/40; E21B 43/25

(57) ABSTRACT

A logging tool is disposed in a wellbore during an acidizing operation. The logging tool may be an acoustic tool, a resistivity tool, or a neutron tool. Measurements are made using the logging tool on a region of a formation penetrated by the wellbore and being subjected to the acidizing operation. A formation property is inferred at one or more depths of investigation within the region using the measurements, and acidizing operation management decisions are made based on the determined inferred property. The inferred property may also be simulated. A minimized difference between the inferred formation property and the corresponding simulated formation property is determined, and acidizing operation management decisions are made based on the determined difference. The inferred property may be acoustic velocity, conductivity peak observation time, near-to-far detector count ratio, or porosity. An acidizing operation management decision may be to maintain, increase, or decrease an acid injection rate.

### CROSS-REFERENCE TO RELATED APPLICATIONS

This application claims, under 35 U.S.C. §119, priority to and the benefit of U.S. Provisional Patent Application No. 62/027,958, filed Jul. 23, 2014.

### BACKGROUND OF THE DISCLOSURE

Well logging provides a detailed record (through a well log) of the geologic formations (e.g., carbonate rock) penetrated by a borehole. It has been extensively used as a mapping technique for exploring and characterizing the subsurface and evaluating the hydrocarbon production potential of a reservoir, along with the identification of other properties of the formation. Well logging provides useful measurements that may be used to extract information about the rock formation related to, for example, porosity, lithology, potential presence of hydrocarbons, and pore-filling fluids. Measurement techniques are based on at least three broad physical aspects: electrical, acoustic (which includes sonic), and nuclear.

The first logging technique measured the electrical conductivity of a formation and used electrodes. The original induction electrical logging tool had a transmitter (magnetic dipole) and a receiver. The magnetic field from the transmitting dipole induced ground loop currents in the surrounding formation that gave rise to an alternating magnetic field that was sensitive to the formation conductivity. The induced alternating magnetic field was detected by the receiver and the conductivity of the formation through which the signal had passed could be determined. For instance, a reservoir formation filled with hydrocarbon could be recognized on a typical electrical log since it was more resistive than the salt water that was commonly found in deeply buried reservoir rocks. The first well log dates back to 1927, performed in the Pechelbronn field in Alsace, France. Since that time, research and engineering efforts have improved this technology to accommodate harsh well conditions and to investigate complex reservoir properties.

An acoustic or sonic logging tool transmits a sound pulse into the formation that is subsequently detected by a receiver. The speed at which the sound (i.e., acoustic wave) propagates through the formation depends at least in part on the formation's mineral composition and porosity. The measured travel time allows one to determine a sonic velocity that can be used to determine the porosity via the well-known Wyllie time-average relation.

Another logging tool designed for formation evaluation uses Gamma rays and neutrons to characterize the geological formation. The absorption of Gamma radiation is proportional to the density of the formation, while that of neutrons is proportional to the amount of hydrogen present. Gamma ray and neutron logs can be indicative of the porosity distribution.

Production logging tools include a variety of sensors that are used to identify the nature and behavior of fluids in or around the borehole during production. They provide useful information such as temperature, flow rates, and fluid capacitance/impedance. Surveys may be performed during production operations to evaluate the dynamic well performance (i.e., the productivity of different zones) and to diagnose possible well problems.

Logging while drilling (LWD) tools allow for detailed formation evaluation as the well is drilled. This allows one to maximize the reservoir value. LWD tool logs allow drilling engineers to make appropriate decisions for particular realized drilling circumstances and optimally direct the direction of the drill. Different measurements are available using LWD technology and their selection depends on the complexity associated with the mineralogy, texture, and open fractures within a target zone near the wellbore. The measurements tools may include Gamma ray tools, electrical resistivity propagation tools, acoustic/sonic logging tools, neutron porosity tools, and nuclear magnetic resonance (NMR) tools.

Acidization is used extensively in well stimulation operations to increase the permeability of carbonate rocks, thus facilitating the flow of oil to the wellbore. As acid is injected into the porous medium (carbonate rock), highly-permeable channels or “wormholes” are formed by the dissolution of carbonate material. A successful matrix treatment produces thin, but deep wormholes with a minimal amount of injected acid.

### SUMMARY

A logging tool is disposed in a wellbore during an acidizing operation. The logging tool may be, but is not limited to, an acoustic tool, a resistivity tool, a dielectric tool, a gamma ray tool, or a neutron tool. Measurements are made using the logging tool on a region of a formation penetrated by the wellbore and being subjected to the acidizing operation. A formation property is inferred at one or more depths of investigation within the region using the measurements, and acidizing operation management decisions are made based on the determined inferred property. The inferred property may also be simulated. A minimized difference between the inferred formation property and the corresponding simulated formation property is determined, and acidizing operation management decisions are made based on the determined difference. The inferred property may be acoustic velocity, conductivity peak observation time, near-to-far detector count ratio, or porosity. An acidizing operation management decision may be to maintain, increase, or decrease an acid injection rate.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. Embodiments are described with reference to the following figures. The same numbers are generally used throughout the figures to reference like features and components.

FIG. 1 depicts, a downhole array device (e.g., acoustic or electrical) deployed on a conveyance mechanism such as coiled tubing, in accordance with the present disclosure.

FIG. 2 depicts a formation (e.g., carbonate rock) that is discretized using one or more simulation blocks (or boxes) for use with an acidizing simulation model, in accordance with the present disclosure.

FIG. 3 depicts possible variations of pore volume at breakthrough (PVBT) with acid injection rate, in accordance with the present disclosure.

FIG. 4 depicts a typical acoustic waveform recorded in a borehole, in accordance with the present disclosure.

FIG. 5 depicts a graph of porosity versus interval transit time from field observations and from computation, in accordance with the present disclosure.

FIGS. 6A-6C schematically show different depths of investigation resulting from different arrays, in accordance with the present disclosure.

FIGS. 7A-7E depict reactive flow simulations showing wormhole formation and propagation at different instances, in accordance with the present disclosure.

FIG. 8 is a graph showing transient variations of acoustic wave propagation velocity measured for different depths of investigation, in accordance with the present disclosure.

FIG. 9 is a graph showing transient variations of the wormhole penetration and its corresponding penetration speed, in accordance with the present disclosure.

FIG. 10A is a graph comparing transient variations of the effective conductivity over time for different acids (formic and hydrochloric) used for the stimulation treatment, in accordance with the present disclosure.

FIG. 10B is a graph comparing transient variations of the acoustic velocity over time for different acids (formic and hydrochloric) used for the stimulation treatment, in accordance with the present disclosure.

FIG. 11 depicts variations of the resistivity with the dimensionless acid concentration (15% HCL), in accordance with the present disclosure.

FIGS. 12A-12D depict conductivity patterns obtained for different acid injection rates, in accordance with the present disclosure.

FIGS. 13A-13D depict transient variations of the effective conductivity (in Siemens/cm) measured for different depths of investigation and for different acid injection rates, in accordance with the present disclosure.

FIG. 14 depicts a response function (geometric factor map) assumed for the conductivity measurements of FIGS. 13A-13D, in accordance with the present disclosure.

FIGS. 15A-15D depict transient variations of the time difference in the effective conductivity for different acid injection rates, in accordance with the present disclosure.

FIG. 16 is a flowchart for optimizing a matrix acidization treatment while pumping acid, in accordance with the present disclosure.

FIG. 17 is a flowchart for optimizing a matrix acidization treatment while pumping acid when the injection rate is considered higher than optimal, in accordance with the present disclosure.

FIG. 18 is a flowchart for optimizing a matrix acidization treatment while pumping acid when the injection rate is considered lower than optimal, in accordance with the present disclosure.

FIG. 19 depicts a downhole array device (e.g., resistivity) deployed on coiled tubing to inject a limited acid volume into a limited injection zone, in accordance with the present disclosure.

FIG. 20A is a schematic illustration of neutron elastic scattering, in accordance with the present disclosure.

FIG. 20B is a schematic illustration of a thermal neutron logging tool, in accordance with the present disclosure.

FIGS. 21A and 21B depict calibration curves to convert a measured counting rate ratio, via slowing-down length Lₛ, to the porosity, in accordance with the present disclosure.

FIGS. 22A-22F depict various stages of wormhole formation and propagation during an acidizing operation, in accordance with the present disclosure.

FIG. 23 is a plot of the counting rate ratio versus elapsed time, normalized by the time-to-breakthrough, in accordance with the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

Some embodiments will now be described with reference to the figures. Like elements in the various figures may be referenced with like numbers for consistency. In the following description, numerous details are set forth to provide an understanding of various embodiments and/or features. However, it will be understood by those skilled in the art that some embodiments may be practiced without many of these details and that numerous variations or modifications from the described embodiments are possible. As used here, the terms “above” and “below”, “up” and “down”, “upper” and “lower”, “upwardly” and “downwardly”, and other like terms indicating relative positions above or below a given point or element are used in this description to more clearly describe certain embodiments. However, when applied to equipment and methods for use in wells that are deviated or horizontal, such terms may refer to a left to right, right to left, or diagonal relationship, as appropriate. It will also be understood that, although the terms first, second, etc. may be used herein to describe various elements, these elements should not be limited by these terms. These terms are used to distinguish one element from another.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

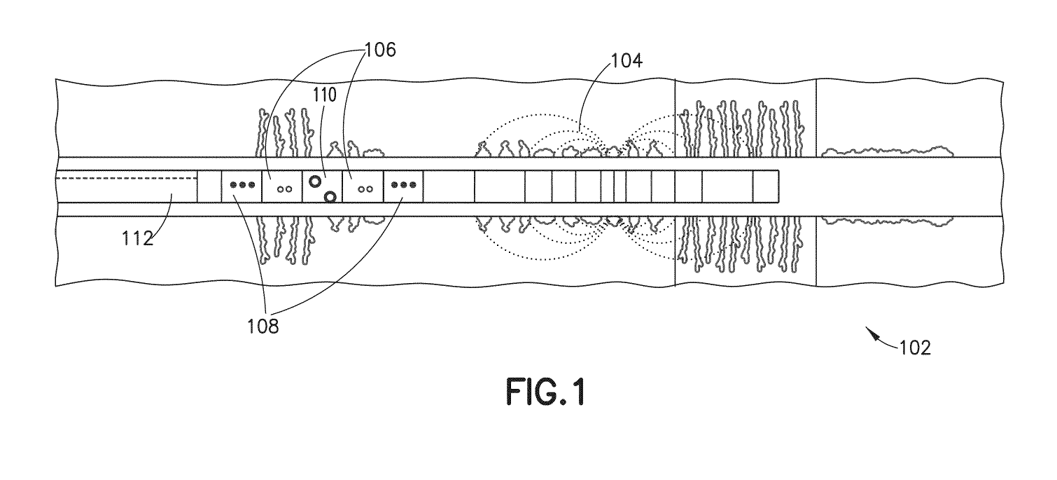

A system and method to monitor matrix acidizing or acidization is disclosed. Matrix acidizing facilitates oil flow from a formation to a drainage or production wellbore. Reservoir management decisions may be based on in-situ, real-time measurements of a reservoir formation (e.g., carbonate rock) undergoing acidization. In the embodiments described herein we specifically refer to carbonate rocks as the acidized formation, but other rock types may be treated in the same manner or in a similar manner adapted for a particular rock type. Logging tools such as that shown in FIG. 1 may be used for real-time monitoring and control of wormhole formation and propagation. Carbonates and certain other types of rocks may vary in terms of their heterogeneity and thus a prediction of the optimal operating conditions (e.g., injection rate, type of acid, diversion agents, etc.) for acidizing a specific area undergoing exploitation is a challenging task. Disposing instruments like logging tools into the wellbore to obtain real-time measurements (e.g., a series of well logs covering the depth range of expected wormholes) while the formation is undergoing acidization may provide useful, real-time guidance to a reservoir manager. That is, changes and trends of variations of those measurements can be interpreted to track the penetration of wormholes and to detect areas in which the acidization may not be progressing in accordance with plan.

FIG. 1 shows a schematic of a logging tool 102 that could represent either a resistivity logging tool or an acoustic logging tool. As described below, other logging tools may be used—the embodiment of FIG. 1 is merely an example. The logging tool 102 shown has multiple arrays 104 (resistivity or acoustic) along with sensors 106 e.g. capacitance sensor, flow meters 108, and acid injection ports 110. The tool is deployed on coil tubing 112.

In one embodiment, a two-scale continuum model may be used to simulate the 3-D dissolution process of carbonate rocks. Various logging tools may be used to obtain measurements such as dynamic conductivity, neutron count ratios, and acoustic measurements. A Wyllie time-averaged equation may be used to evaluate, for example, variations in the acoustic wave propagation velocity resulting from the dynamic change in the porosity during the dissolution process. The acoustic measurements may yield insight into the type of acidizing regimen to use and to estimate the depth and speed of wormhole penetration. Real-time acoustic (or sonic) measurements may allow one to predict the optimal operating conditions for creating production-enhancing wormholes.

The two-scale continuum model describes the reactive transport of acid species at Darcy scale, but also captures the pore-scale physics. The Darcy scale model includes the equations that govern acid transport, continuity, chemical dissolution reaction, and porosity evolution. The pore-scale model has structure-property relations wherein Darcy scale properties such as permeability, pore radius, and solid-fluid interfacial area per unit volume are given as functions of the local porosity. The two-scale continuum model allows for the prediction of wormhole formation, whereby time-dependent wormhole creation correlates to porosity changes as a function of time.

The model thus determines porosity as a function of time. Using the instantaneous porosity, along with the treatment fluid properties, the model calculates an expected formation property (e.g., travel time, conductivity, and neutron near-to-far counting rate) (i.e., perform forward modeling). The measured and calculated property values may be compared in an inversion to optimize the input formation properties and acid injection rate (i.e., perform inversion modeling).

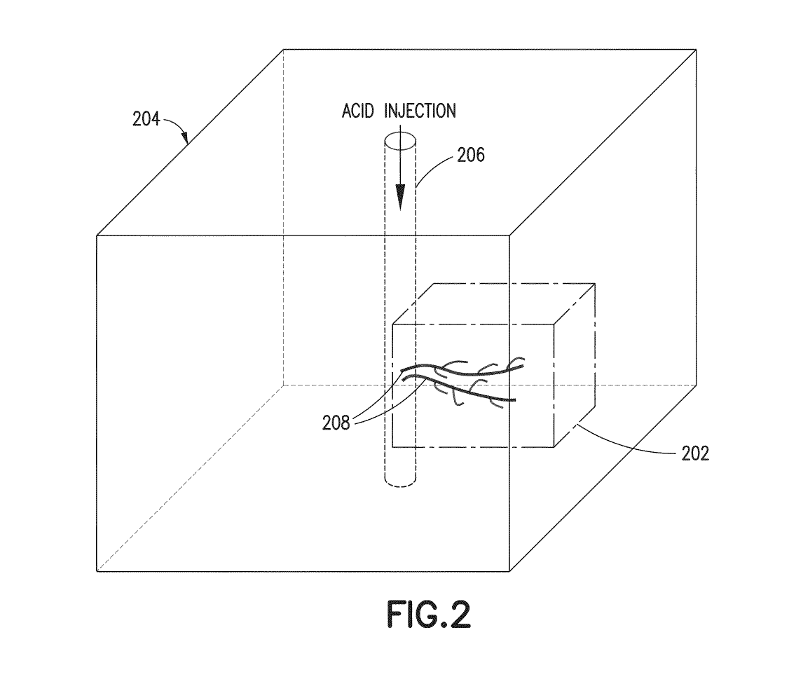

In FIG. 2, a simulation box 202 is selected from within a formation 204 of interest penetrated by a wellbore. The simulation box 202 is a parallelepiped-shaped core (e.g., a 60 cm×15 cm×30 cm rectangular parallelepiped or rectangular cuboid section of the formation) that is discretized into grid blocks and numerically simulated while assuming the inlet face (i.e., the face forming at least a portion of the borehole wall 206 undergoing acidization) is in direct contact with acid. An initial (pre-acidization) pore distribution is introduced by perturbing the initial average porosity E₀ (taken to be 20%) with random fluctuations that are assumed to be uniformly distributed in the closed interval [−0.1ε₀, +0.1ε₀]. The distribution of the initial permeability is computed from the well-known Carmen-Kozeny relation. The acid (e.g., 15% HCl) is assumed to be injected over the entire inlet face. For each grid block, the dynamic evolution of the porosity, the time-dependent acid concentration, the pressure, and fluid velocity may be determined.

As acid is injected into the porous medium 204 (carbonate rock), highly-permeable channels (wormholes) 208 form as a result of the dissolution process, which is the manifestation of the acid-carbonate reaction. Experimental and numerical studies have shown a strong dependence of the dissolution patterns on the injection rate of acid. At low injection speeds, the acid is entirely spent before penetrating into the medium (due to flow expansion in transverse directions) and the whole face of the formation is dissolved (face dissolution). At very high injection speeds, the acid may penetrate deep into the formation, but the reaction to the acid takes place over a large region, yielding a uniform increase in the porosity (uniform dissolution).

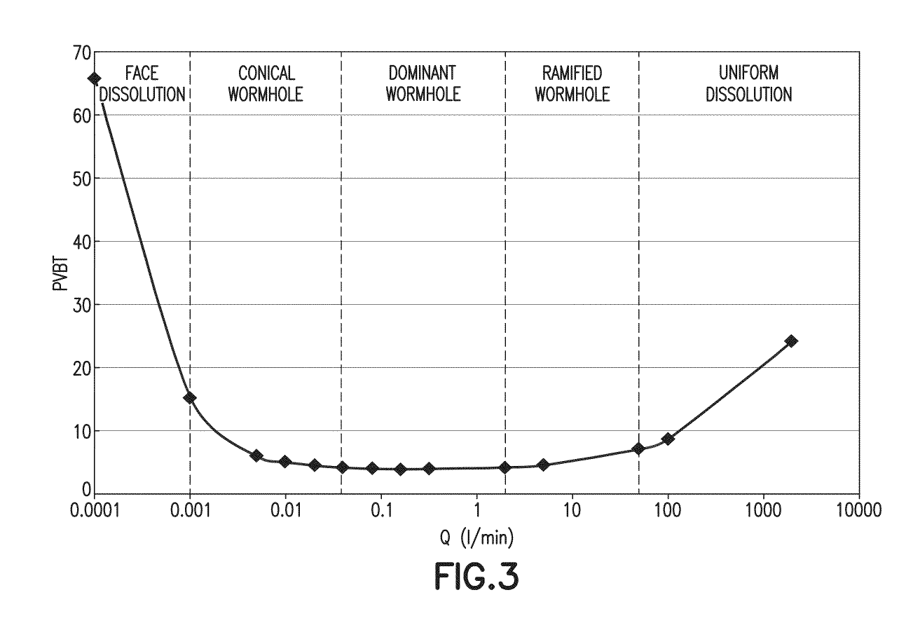

FIG. 3 depicts the variation of the pore volume at breakthrough (PVBT) with the acid injection rate. PVBT is the amount of acid per pore volume to reach breakthrough (i.e., the face opposite the injection face), and is given by:

$$P V B T = \frac{{QT}_{BT}}{V Φ} , \qquad ( 1 )$$

where Q is the acid injection rate, T_{BT} is the time taken to achieve breakthrough, V is the volume of the simulation formation cuboid, and Φ is the porosity. For both high and low acid injection rates, a large amount of acid is required to achieve breakthrough. PVBT reaches its approximate minimum over a wide range of intermediate values of injection rate. A flat curve is observed near the optimum-to-high rate region, while there is a steeper slope in the low-to-optimum rate region. This indicates that the optimum PVBT is more sensitive to a decrease in the injection rate than to an increase. Also shown are the ranges of acid injection rates that give rise to different acidizing regimes.

An optimal matrix treatment involves the production of thin wormholes with a small amount of injected acid so as to enhance the oil flow to the wellbore. Operating conditions and parameters such as the acid properties, the reaction kinetics and mass transfer, and the heterogeneity and properties (e.g., initial porosity, average pore radius, etc.) of the carbonate formation can affect the dissolution process and wormhole propagation. This makes the acidizing job challenging in the field. However, the acquisition of real-time information using logging technology adds a new dimension to acidizing operations. For instance, the velocity of the propagation of a wave or pulse generated by an acoustic transmitter is sensitive to the porosity of the formation. The variations of this velocity can be measured and derived from a sonic logging tool placed in the borehole during the acidizing operation, and useful information can be extracted on wormhole formation and propagation. This provides operators with a real-time indication of the progress of the acidizing process downhole. Thus, in one embodiment, a sonic logging tool has an acoustic transmitter for generating acoustic pulses and at least one receiver for detecting received waves. (While a sonic tool is sometimes restricted to acoustic waves in the range of 1 to 25 kHz, the tool is not limited to those frequencies herein, “acoustic” and “sonic” is used interchangeably, as they often are, to include the full range of detectable acoustic waves.) The tool is disposed in a borehole, thereby measuring the velocity of acoustic wave propagation in the formation, which can then be related to the formation porosity.

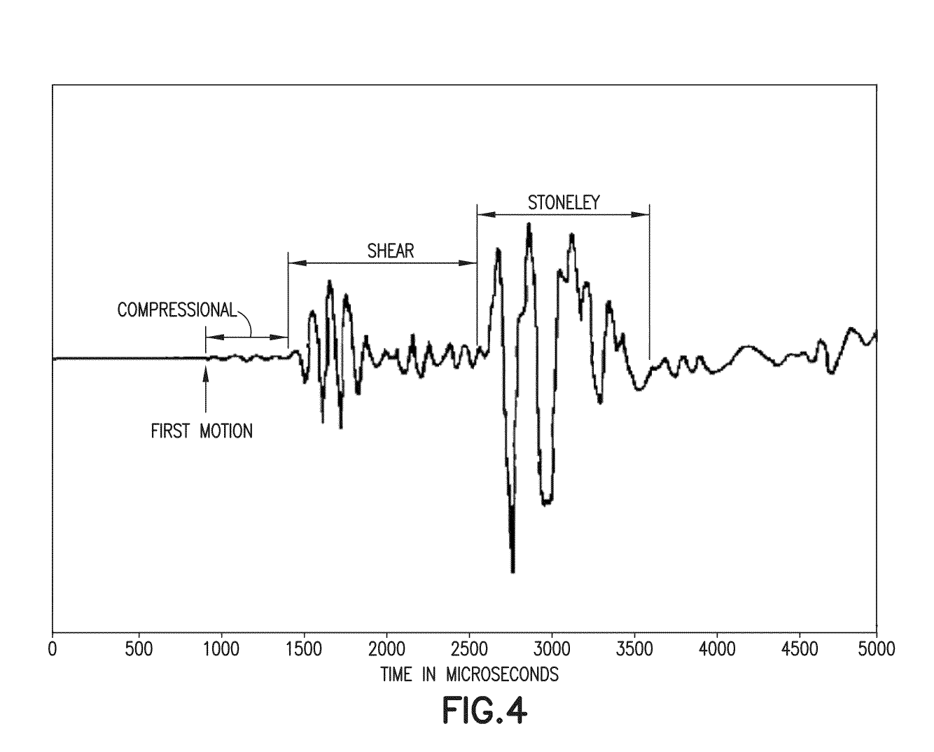

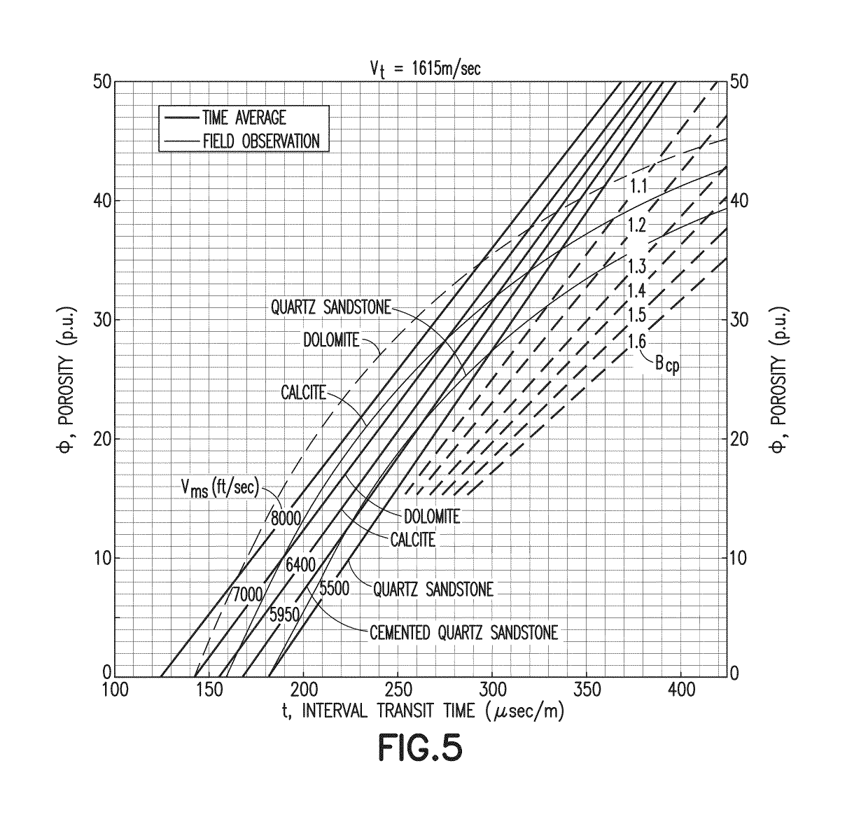

FIG. 4 depicts a typical acoustic waveform recorded with a sonic logging tool in a borehole. Three wave arrivals are observed: compressional, shear, and Stoneley. For porosity evaluation, the time Δt it takes to observe the compressional wave arrival is recorded and related to the porosity of the medium through the Wyllie time-averaged equation. This equation is a volume-weighted average of the transit times of the different constituents comprising the rock (e.g., solids, water, gases, and oil):

$$\frac{1}{V} = \frac{1}{{V}_{mat}} ( 1 - φ ) + \frac{1}{{V}_{f}} φ \qquad ( 2 )$$

where Vₘₐₜ is the velocity of wave propagation through the rock matrix, V_{f} is the corresponding velocity through the saturating fluid(s), and φ is the porosity. The plots shown in FIG. 5 map sonic log interval transit time Δt to porosity φ for rocks with different lithology. The lines are obtained using the above time-averaged equation, and the curves are based on experimental observations. For each case, the saturating fluid is assumed to be water with an acoustic wave velocity of approximately 1615 m/sec. Table 1 presents representative velocities for three different rock types. In the following illustrative simulations, we consider the carbonate formation to be limestone.

TABLE 1
Velocity of acoustic wave propagation through different rock types

| Lithology | Vₘₐₜ (m/sec) |
|---|---|
| Sandstones | 5486-5944 |
| Limestones | 6400-7010 |
| Dolomites | 7010-7925 |

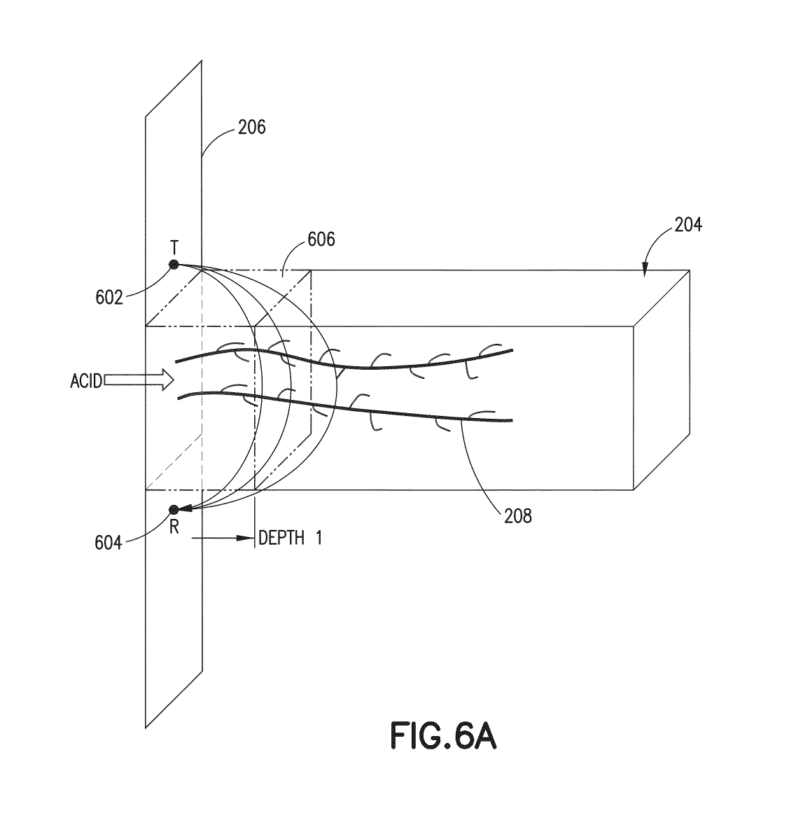

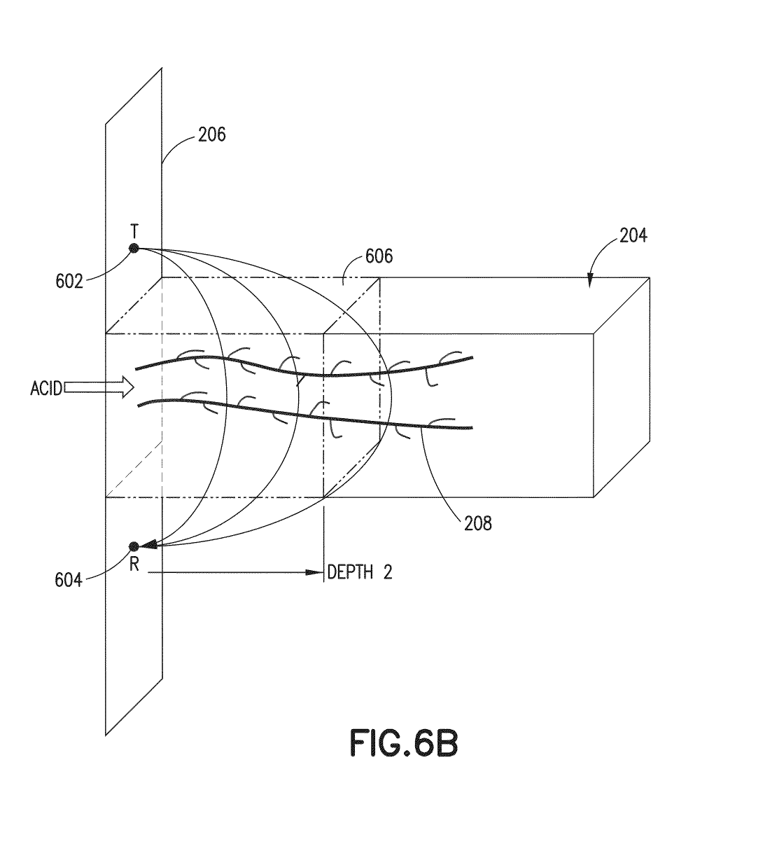

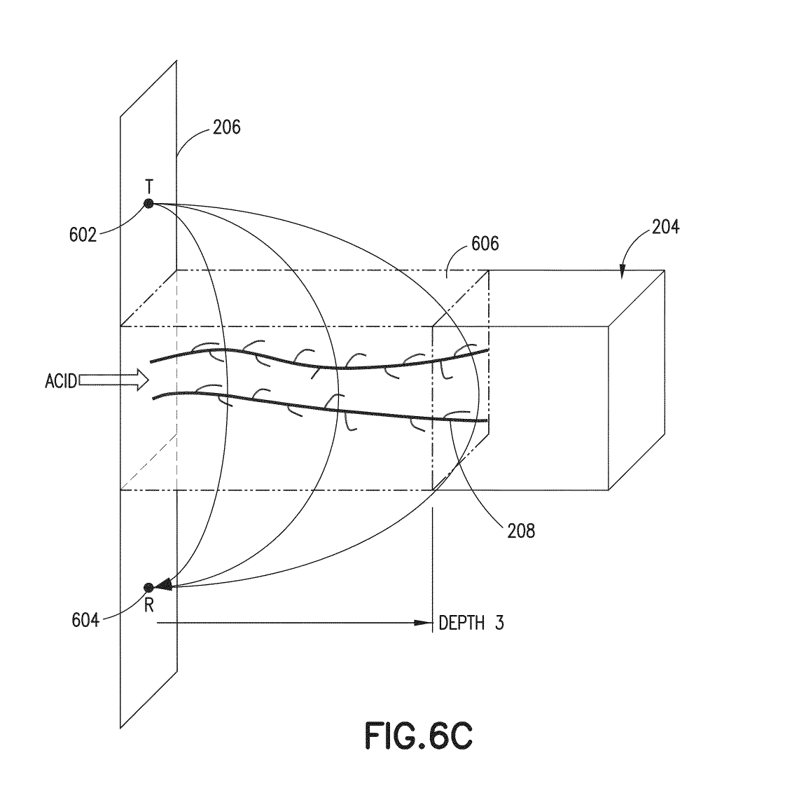

As shown in FIGS. 6A-6C, by varying the distance between the transmitter 602 and receiver 604 antennas, the depth of investigation (DOI) 606 into the formation 204 can be varied. Commercially available logging tools operate with an array of receivers 604 and are capable of investigating different depths of investigation at the same time.

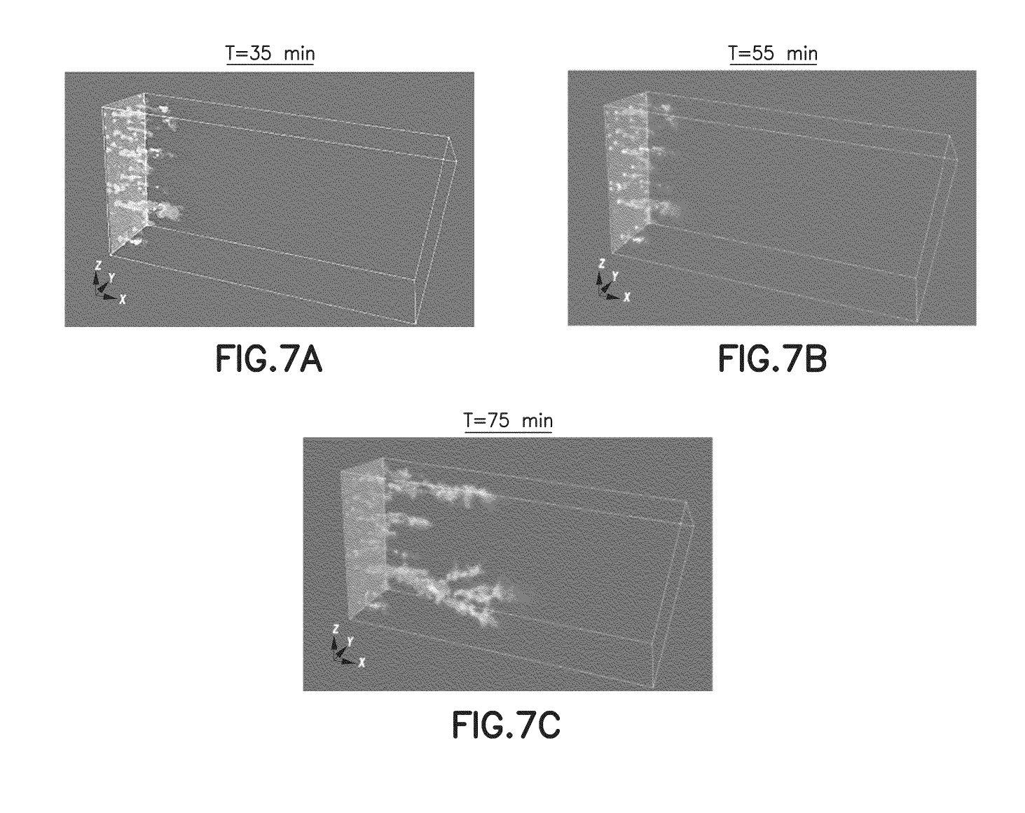

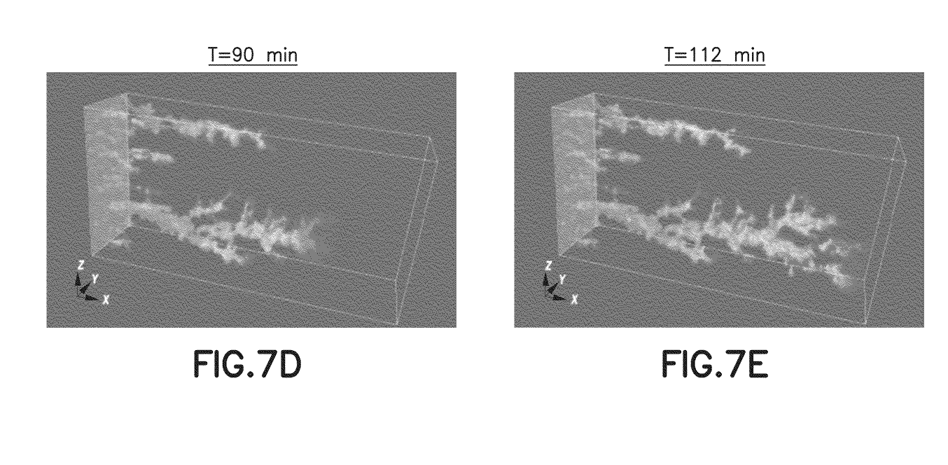

Simulation results showing wormhole formation and propagation resulting from the reactive dissolution process are illustrated in FIGS. 7A-7E. The data were obtained at different times while injecting acid onto the inlet face. The injection rate was set equal to Q=0.16 I/min. Several thin wormholes formed at the inlet face, while a few wormholes penetrated deep into the carbonate.

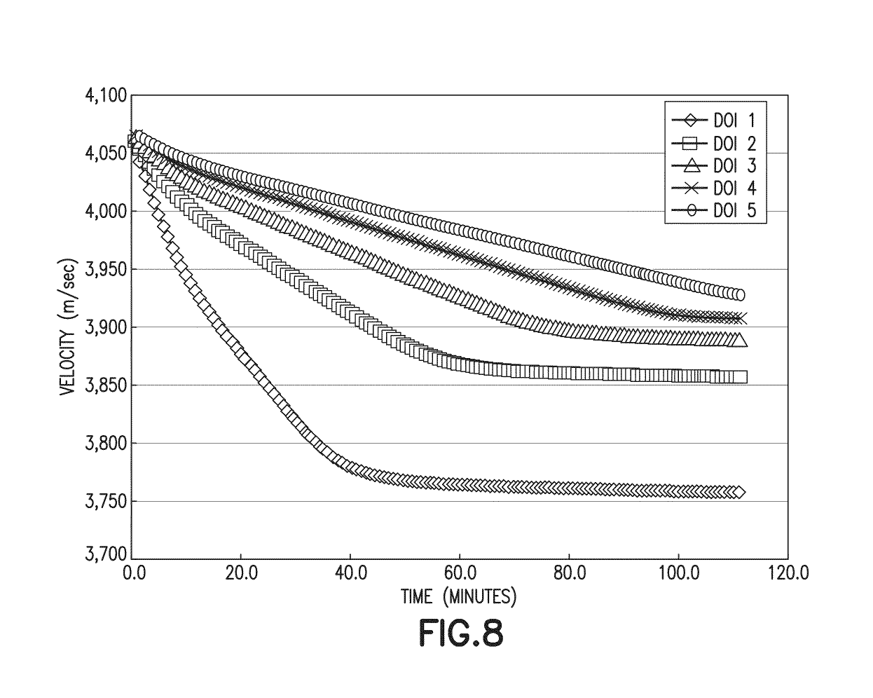

Variations in the acoustic wave propagation velocity as derived for a sonic logging tool for different depths of investigation are plotted in FIG. 8. Note that the velocity is computed in the average sense as follows:

$$V \approx \frac{{\sum }_{i} {V}_{i}}{N} \qquad ( 3 )$$

where N is the number of cells (including the cells that are not affected by the acidization) in the part of the formation sensed by the acoustic tool. A velocity decrease is initially observed as acid dissolves the rock matrix, and then it stabilizes to a steady-state value. This is expected since the solid matrix with a high sonic velocity is being replaced with water having a lower sonic velocity. The transient changes in the acoustic wave propagation velocity indicate wormhole formation and propagation is occurring.

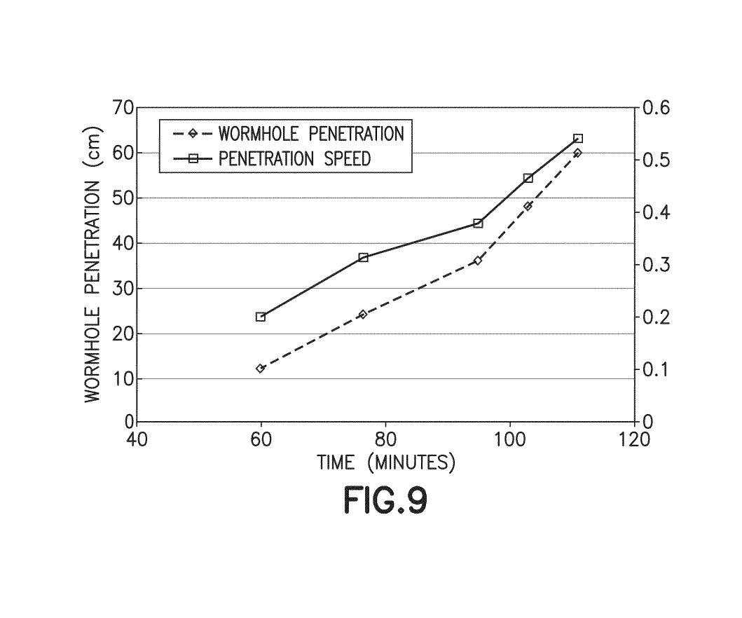

Moreover, one can exploit the acoustic measurements retrieved from an array of receivers (placed at different distances from the transmitter) that provide different depths of investigation (as shown in FIGS. 6A-6C and 8) to track the wormhole penetration and corresponding acoustic wave speeds. The time-to-breakthrough for each volume is derived from the stabilization of the acoustic measurements. FIG. 9 depicts the evolution of the wormhole penetration (diamonds) and its speed (squares). The wormhole penetration speed increases with time. Increasing the number of receivers allows for a more refined track of the wormhole's penetration. Differences between measured or inferred formation properties and corresponding simulated properties can be minimized by iteratively adjusting simulation input parameters, and the minimized differences (and corresponding formation simulation input parameters) may be used as a basis for making acidizing operation management decisions.

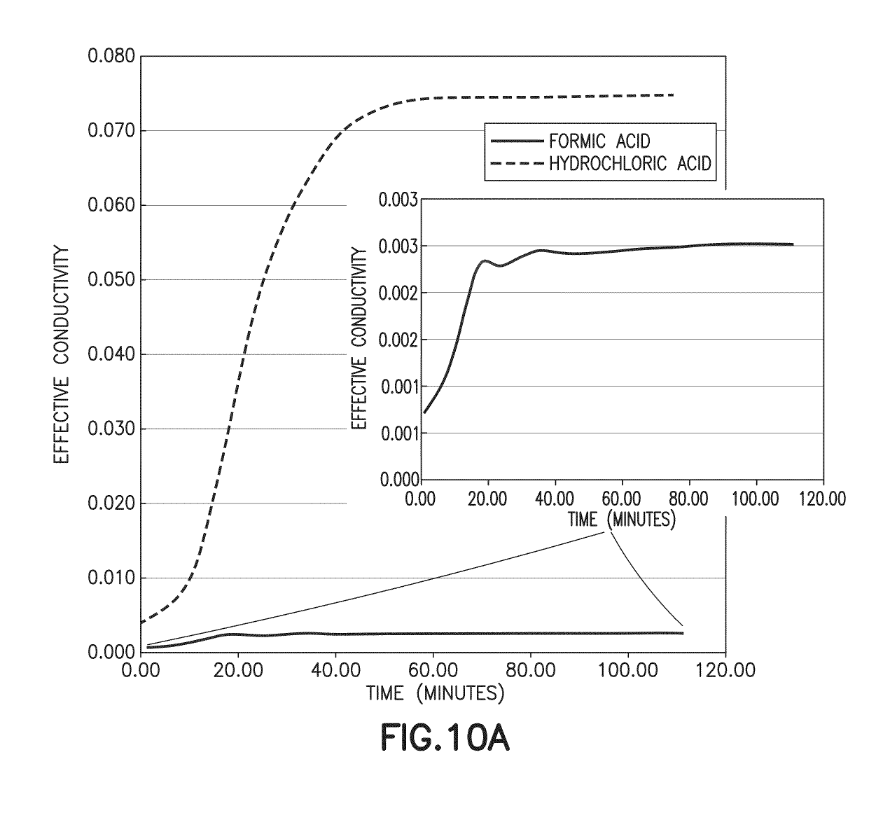

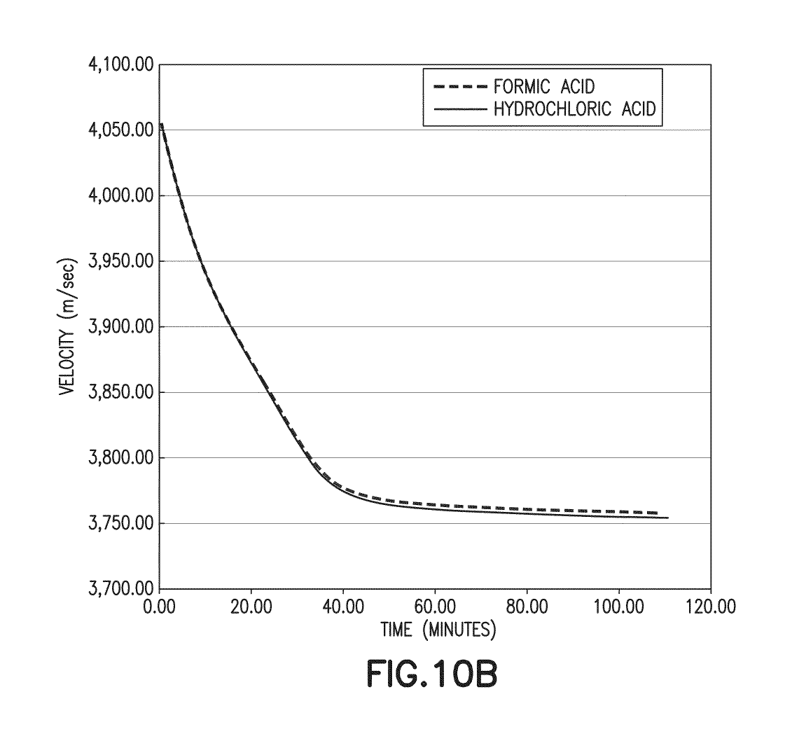

FIGS. 10A and 10B, respectively, show the transient variations of the effective (electrical) conductivity and the velocity of acoustic wave propagation obtained at one depth of investigation during an acidizing operation in which both hydrochloric and formic acids were injected. Archie's law was employed to evaluate the variations in the electrical conductivity resulting from the dynamic change in the porosity and the fluid conductivity during the dissolution process. For organic acids, such as formic acid, the contribution of the acid conductivity to the acidizing process is opposite to that of HCl. Formic acid is less conductive than its reaction product, calcium formate, so during the acidizing job the overall conductivity increases until it eventually reaches an equilibrium value. The inset plot in FIG. 10A shows the lower (formic acid) curve on an expanded scale.

It is well known in chemistry that a combination of a weak acid and its salt forms a mixture, referred to as a “buffer” that tends to keep the conductivity and pH constant. This can be seen in FIG. 10A in which we observe much lower effective conductivity for the formic acid. As such, an electrical logging tool might not be sufficiently sensitive when using low conductivity acids. However, the velocity responses obtained from the acoustic measurements are overlapping. This is expected since the acoustic measurement is mostly sensitive to the porosity change, while the conductivity measurement is sensitive to the porosity change as well as the conductivity of the fluid in the pore space. These results suggest that one should use sonic logging to monitor acidizing when dealing with low-conductivity acids.

As the above would suggest, in an alternate embodiment, electrical logging tools may be used to enable real-time monitoring and control of matrix acidizing. In-situ, real-time conductivity measurements of a carbonate formation may be made while performing an acidizing operation. An electrical logging tool may be deployed using, for example, coiled tubing and allows one to monitor the changes in the conductivity of the formation undergoing acidization. The conductivity measurements can be interpreted to develop an acidizing regime and track the penetration length of wormholes. An operator can make “on the fly” adjustments to the planned acid regime (e.g., acid injection rate) to improve the efficiency of the treatment.

The concentrations of the different ionic species involved in the reactive dissolution of carbonates, along with the dynamic change in the porosity distribution, continuously affect the electrical resistivity. (It is well known that resistivity and conductivity are reciprocals, and both terms are used herein and elsewhere in an interchangeable, though reciprocal, manner when discussing this property.) As such, the variations of the resistivity during the acidizing operation can be measured and useful information can be extracted regarding wormhole formation and propagation.

Archie' s law serves as the basis to determine the porosity and saturation of the carbonate rock from resistivity measurements as follows:

$$\frac{{R}_{c}}{{R}_{f}} = \frac{1}{{φ}^{m} {S}_{w}^{n}} \qquad ( 4 )$$

where R_{c} is the resistivity of the rock, R_{f} is the resistivity of the fluid in the pores, φ is the porosity, S_{w} is the water saturation, and m and n are the Archie's empirical exponents. In the subsequent analysis, S_{w} is set equal to one. As an example, we consider the chemical reaction between hydrochloric acid and calcite given by:

2HCl+CaCO₃→CaCl₂+CO₂+H₂O (5)

Since the conductivities of the different species on the two sides of this reaction are not the same, as the reaction proceeds, the conductivity of the solution changes. At t=0, before the reaction starts, the conductivity of the solution is just the conductivity of the acid. At each point in time, if we know how much acid has been reacted (spent), from Eq. 5 we know how much reaction products have formed, and using the conductivity of the individual species in Eq. 5, it is possible to calculate the conductivity of the solution.

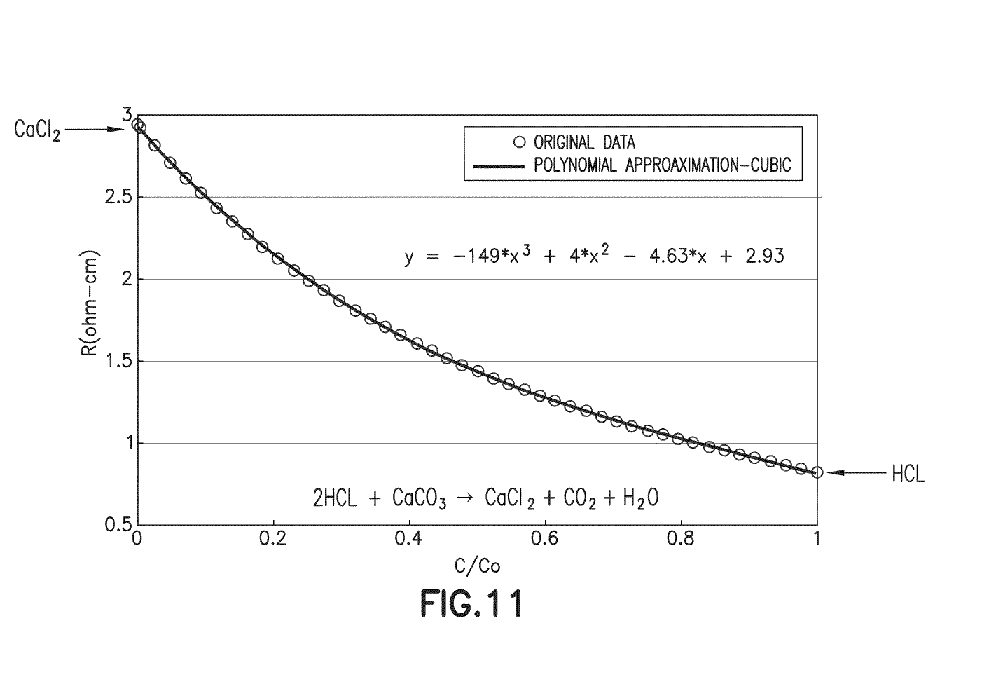

The variation of the resistivity of the solution with its concentration is shown in FIG. 11, as obtained from simulation software for electrolyte chemistry. This dynamic change in the fluid resistivity can be incorporated into an acidizing model by approximating its variations with a cubic polynomial. The hydrochloric acid (HCl) is more conductive than the same concentration of the reaction product CaCl₂. As the acid reacts with the carbonate rock, the concentration of HCl decreases due to consumption by the reaction. The overall conductivity of the solution decreases because the highly conductive HCl is replaced with the less conductive reaction products, particularly CaCl₂. Finally, the conductivity of the solution becomes constant after the acid is completely consumed.

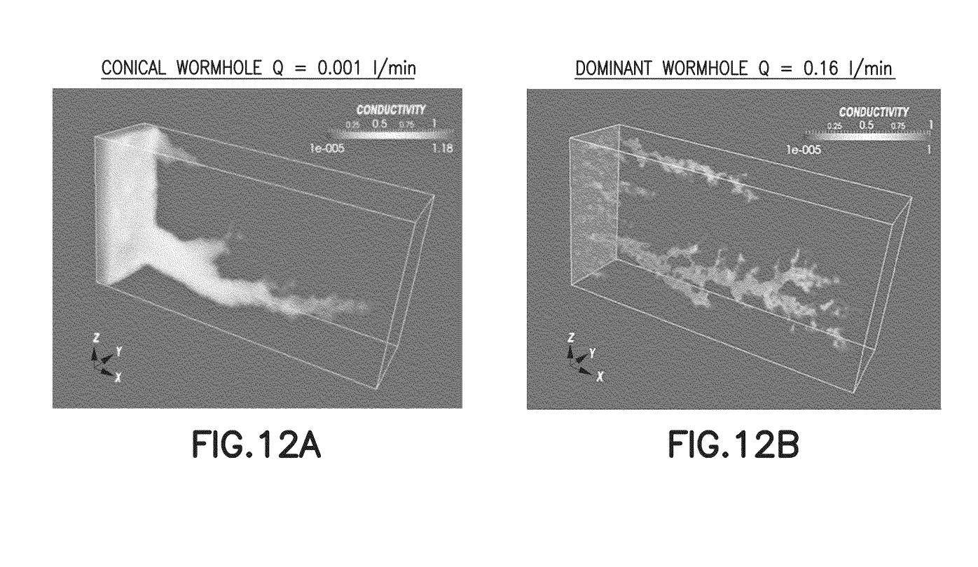

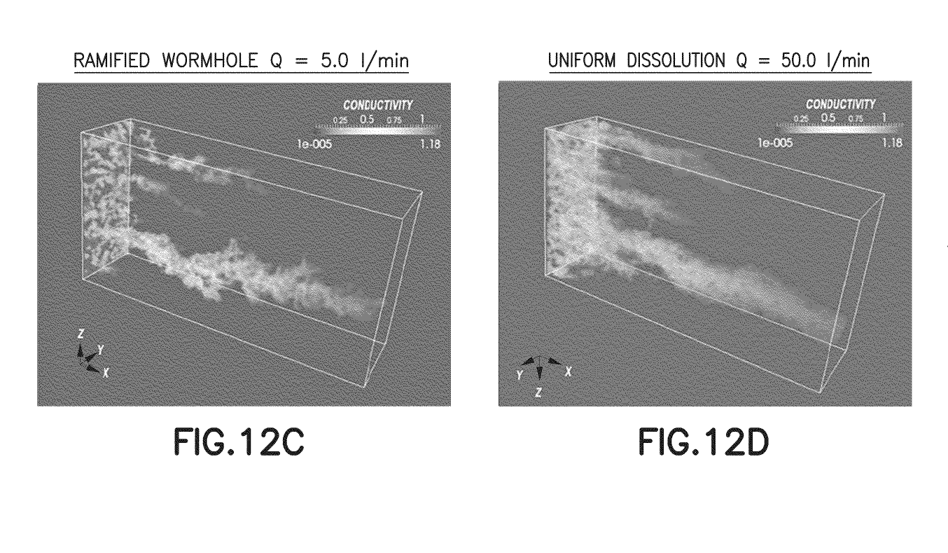

The effect of varying the acid injection rate on the conductivity distribution over the domain resulting from the reactive dissolution process is illustrated in FIGS. 12A-12D. At a low injection rate (e.g., Q=0.001 l/min), a thick wormhole is observed that forms and penetrates into the carbonate. This is referred to as a conical wormhole (FIG. 12A). At the optimal injection rate (for this case, Q=0.16 l/min), several thin wormholes form at the inlet face, while a few wormholes penetrate deep into the carbonate. This is referred to as a dominant wormhole (FIG. 12B). Injecting acid at a higher rate (e.g., Q=5 l/min) yields a wider propagation of wormholes over the carbonate. This is referred to as a ramified wormhole (FIG. 12C). At very high acid injection rates (e.g., Q=50 l/min), the acid penetrates into the whole formation while remaining mostly unreacted. This is referred to as a uniform dissolution (FIG. 12D).

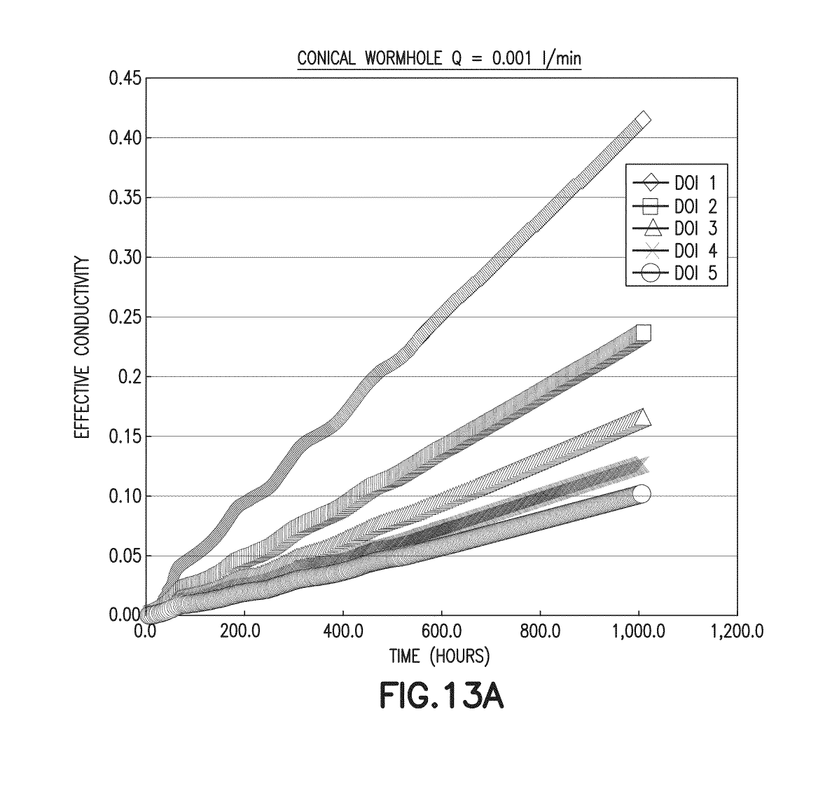

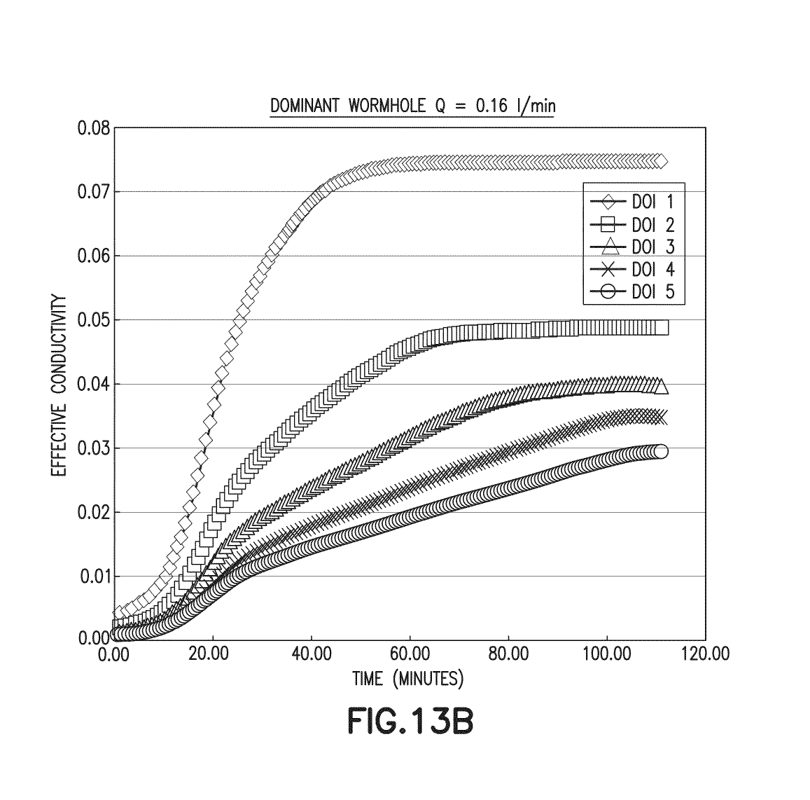

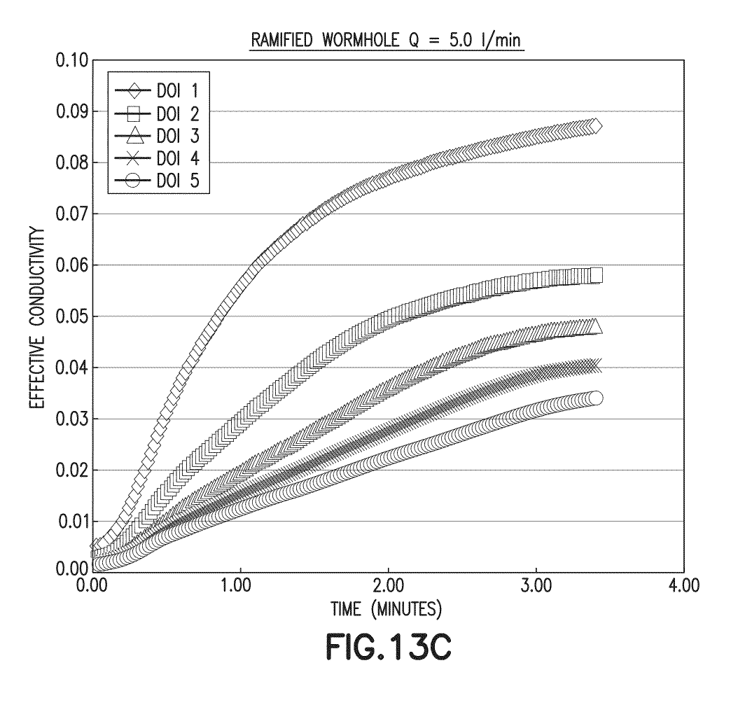

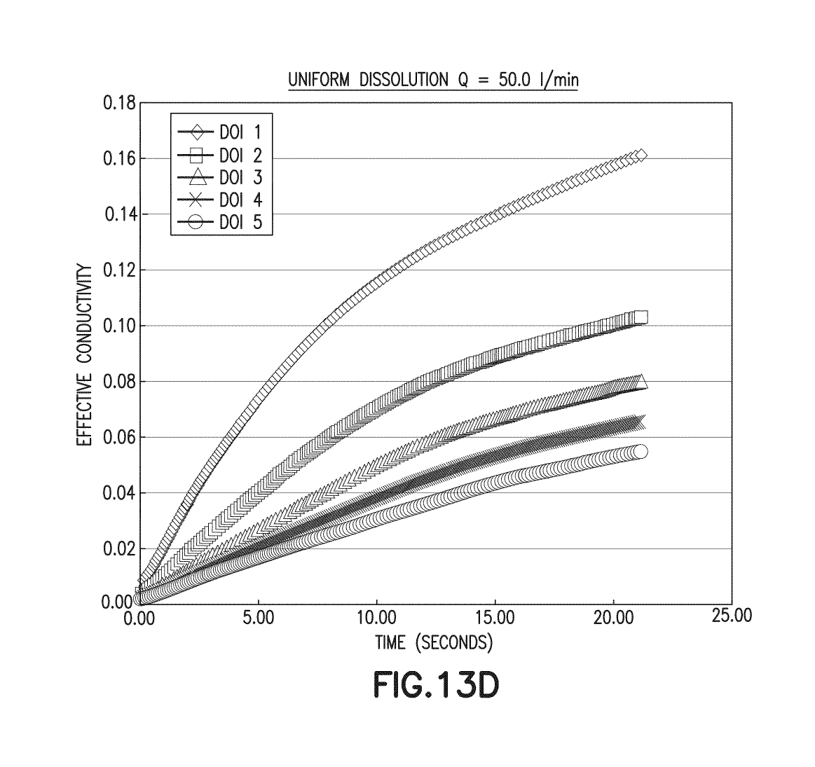

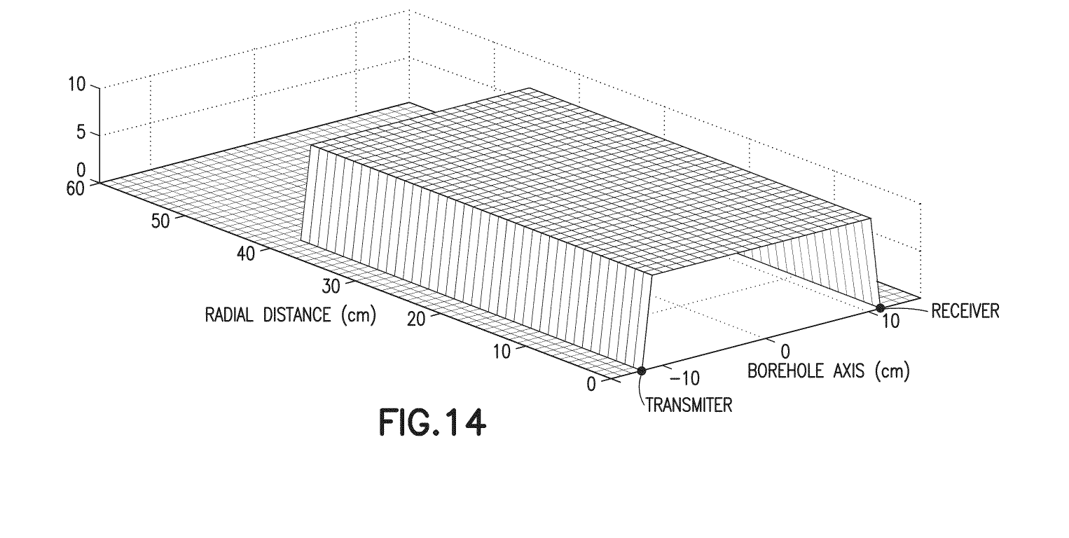

FIGS. 13A-13D are plots of the transient variations of the effective formation conductivity σ_{eff} (assuming a square-type response function F or geometric factor as shown in FIG. 14) for different depths of investigation as a function of the acid injection rate. The effective conductivity σ_{eff} is defined as:

$${σ}_{eff} = \frac{1}{Ω} \int \int \int σ ( x ) F ( x ) d x \approx \frac{{\sum }_{i} {σ}_{i} {F}_{i}}{N} \qquad ( 6 )$$

where Ω is the volume of the formation under investigation, F is the response function, and N is the number of grid blocks within the volume Ω. At low injection rates (FIG. 13A), the variations of the effective conductivity with time increase linearly, while at more optimal rates (FIG. 13B) the effective conductivity undergoes an increase as the acid dissolves the formation and then stabilizes to a steady-state value. This feature can provide a useful indication of the desired acidizing regime. As shown in FIGS. 13C and 13D, increasing the acid injection rate further yields slightly different trends in the transient regime without reaching the plateau observed in the dominant wormhole regime.

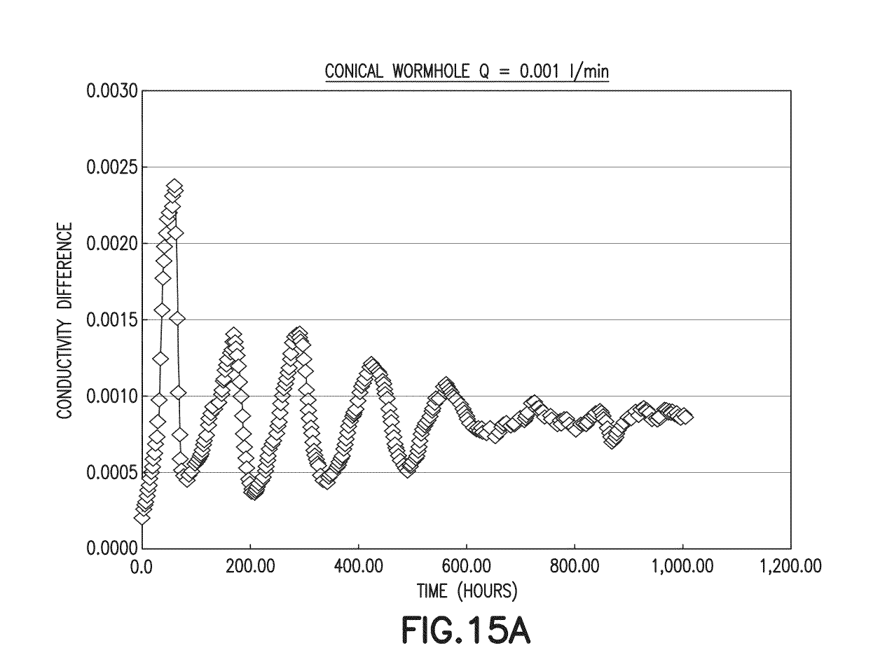

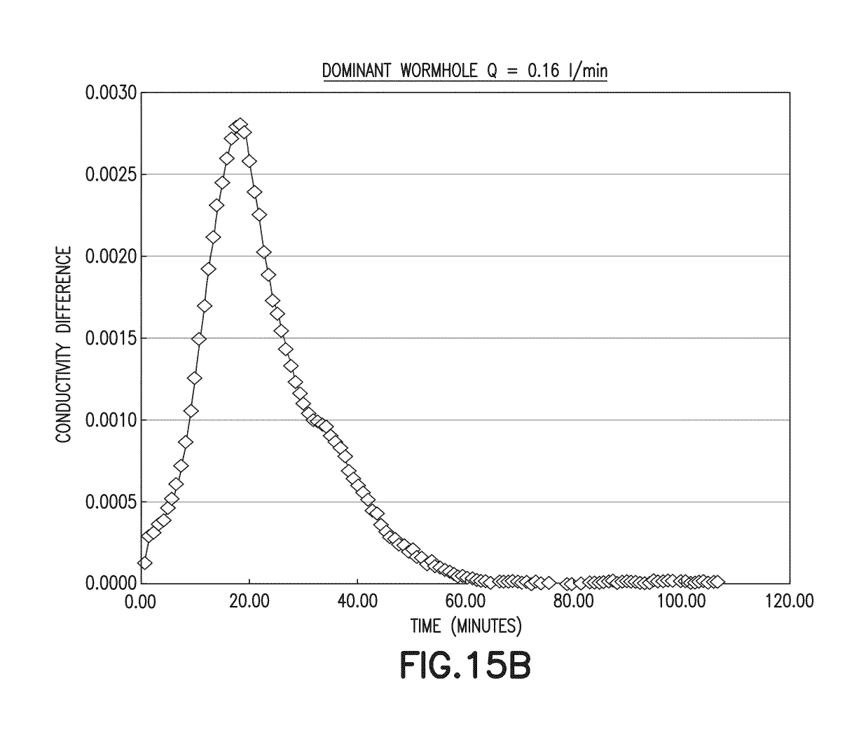

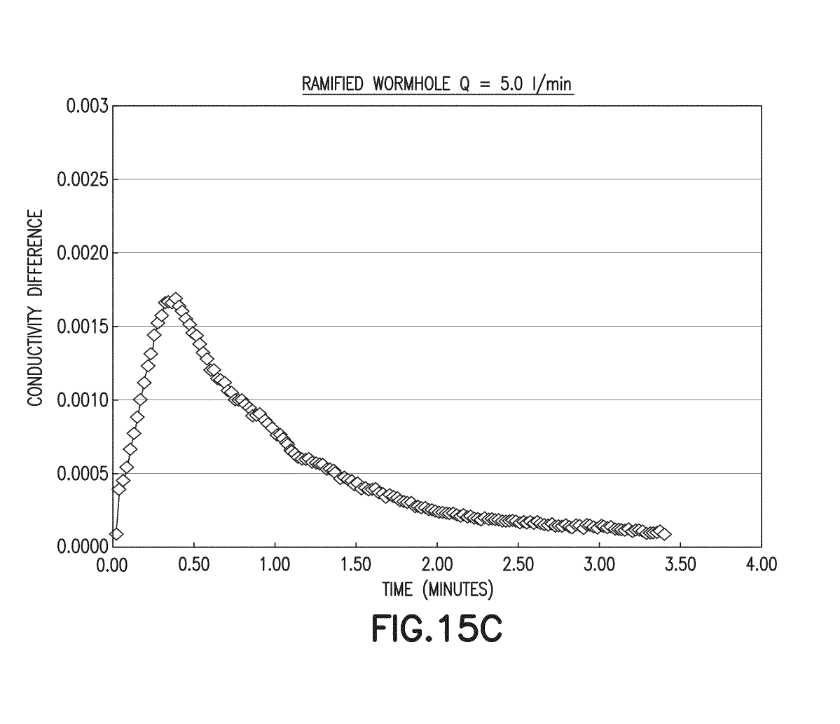

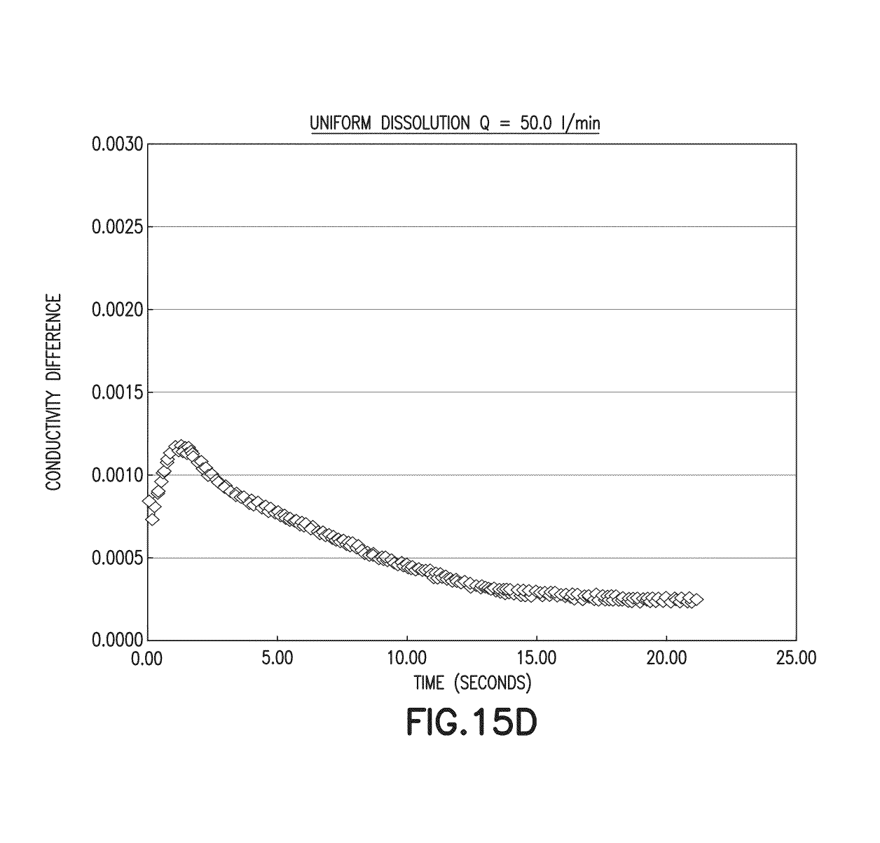

Since electrical logging tools are run on coiled tubing that traverses the wellbore and can perform conductivity measurements at different instances while pumping acid, one may record the difference in the conductivity (rate of increase), σ_{eff}^{t+1}−σ_{eff}^{t}, between consecutive instances and track its time evolution, as shown in FIGS. 15A-15D. Note the results are presented for just one depth of investigation. At low injection rates, fluctuations are observed around a non-zero value (FIG. 15A). Near the optimal rate, the measurements show an asymptotic convergence to zero, indicating stabilization of the effective conductivity for the corresponding depth of investigation (FIG. 15B). Injecting acid at higher rates leads to a smooth convergence to small steady-state values (without oscillations) (FIGS. 15C, 15D). Note that the time scale for the four plots is not the same. Analyzing the magnitude of the maximum conductivity difference and its corresponding time can be indicative of the acidizing regime.

Because the different regime identifiers can be correlated to different acid injection rates, one may optimize the acidization treatment while pumping acid. In one embodiment, an operator performs a “base logging pass” (1602) to determine the baseline properties (e.g., thermal) of the wellbore environment. The operator then injects a “pre-flush” fluid (1604) (e.g., a fluid of different conductivity than the reservoir fluid) and performs one or more logging passes (1606) to determine the injection profile (e.g., using a differential flow (DFLO) sensor and fiber optic distributed temperature sensor) as well as the depth of invasion of the fluid (e.g., using resistivity arrays). This provides a baseline log for determining where the fluids effectively permeate the formation, identifies “thief zones”, and helps in predicting the impact of acid injection during the stimulation phase. The obtained information, along with other input parameters such as formation geometry, wellbore geometry, formation properties (e.g., porosity, heterogeneity), and acid properties (as a function of acid injection rate) are provided to a predictive acidizing model (1620). One result of those calculations is a breakthrough curve similar to what is shown in FIG. 3. This leads to the identification of the “optimal” specific injection rate of acid (barrels per minute per unit length of wellbore) and the injection distribution within the wellbore, at least in accordance with the model assumptions. The operator may also perform conductivity calculations (1624) to determine, as a function of time, the time interval (ΔTₚₑₐₖ) needed to reach a peak in the rate of conductivity increase, similar to what is shown in FIGS. 15A-15D.

Acid is injected at the (numerically predicted) optimal rate (1630). A downhole resistivity tool tracks the rate of conductivity increase while the acid is being injected (1640). The operator monitors the time it takes to observe the first conductivity peak to determine whether this time is within a predefined time interval around the optimal ΔTₚₑₐₖ (1650). If the conductivity peak is observed earlier than expected, the operator alters operations as described below and shown in FIG. 17. If the conductivity peak is observed later than expected, the operator alters operations as described below and shown in FIG. 18. If the time interval to observe the conductivity peak is within the predefined time interval, then the injection rate is deemed optimal and operations continue unaltered (1650). The operator monitors the conductivity rate to ascertain when it becomes stable (1660). Once the conductivity rate is deemed stable, operations may be stopped or continued, as deemed proper by the operator (1670). A flat (i.e., stable) conductivity rate may, for example, indicate that the wormhole has grown deeper than the DOI of the resistivity tool. Based on that information, the operator may choose to stop or continue with the acidizing.

The conductivity peak may be observed earlier than expected if, for example, the injection rate is higher than optimal (see, e.g., FIGS. 15C and 15D). This can be remedied by determining a new optimal injection rate and decreasing the acid flow rate. To do so, the input parameters are adjusted (1710) and the predictive model re-run (1720). Based on those results, an updated optimal injection rate is selected (1730) and an updated time interval ΔTₚₑₐₖ for the arrival of the conductivity peak is determined (1740). Operations are modified or resumed to inject acid at the updated (lower) injection rate (1750A). Alternatively, the operator may increase the effective open zones for injection and continue operations at the higher injection rate (1750B). That is, for the case of higher-than-optimal acid injection rate, the operator can reduce the “specific injection rate” by either reducing the rate or by increasing the length of wellbore into which the fluid (acid) is injected. As a further alternative, the reactivity of the acid being injected may be modified (i.e., increased) (1750C). Ultimately, upon implementing one of those alternatives, the operator monitors the time interval to observe the conductivity peak (1650), as before, and operations continue as described above and shown in FIG. 17 (1760).

There are various alternative ways to determine the adjusted input parameters. In one embodiment, the parameters can be varied parametrically. These variations will produce different predicted conductivity peaks for the specific flow rates used. The predicted conductivity peaks will appear earlier or later than the observed time. It is possible to choose the set of parameters that provide a conductivity peak closest to the observed time. In another embodiment, the running of the predictive model with parametric variation of the input parameters is done before the acidization begins. In a further embodiment, the predictive model is used iteratively as part of an inversion routine that calculates the optimum input parameters that provide a match to the observed conductivity peak for the particular flow rate. In yet another embodiment, the input parameters from neighboring cases are interpolated to find the closest input parameters. As stated above and reiterated here, differences between measured or inferred formation properties and corresponding simulated properties can be minimized by iteratively adjusting simulation input parameters, and the minimized differences (and corresponding formation simulation input parameters) may be used as a basis for making acidizing operation management decisions.

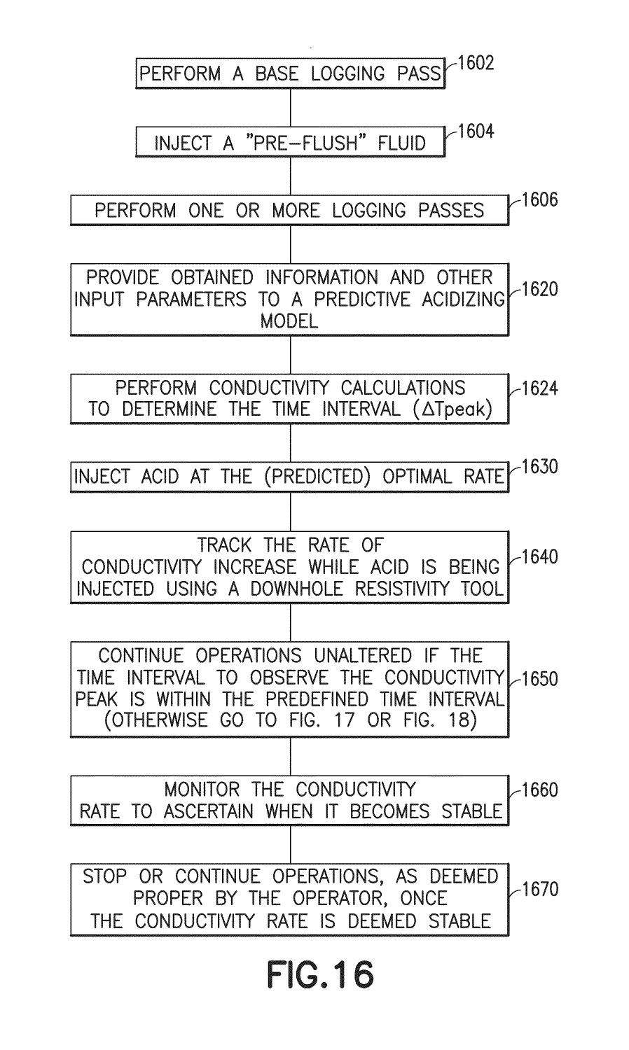

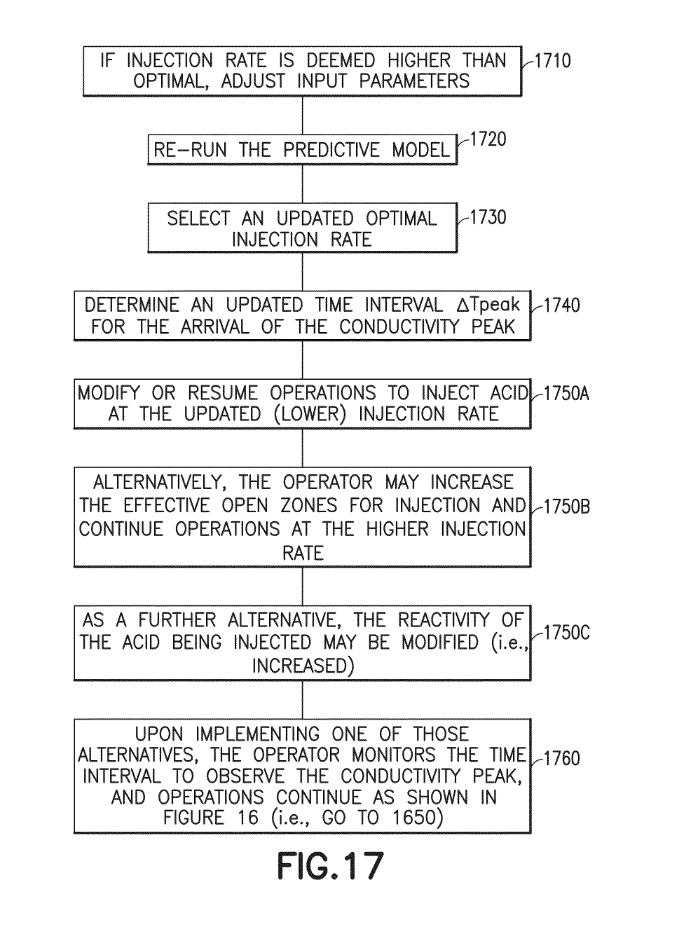

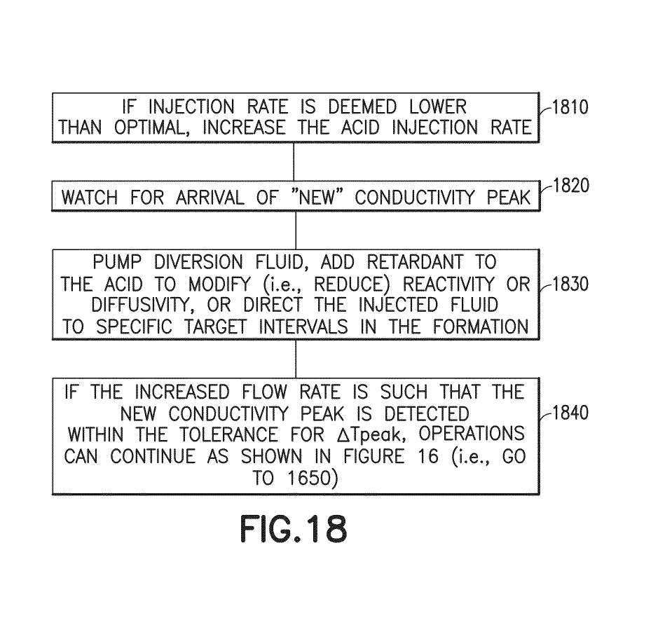

If the elapsed time exceeds the expected ΔTₚₑₐₖ and a conductivity peak has not been observed, any further delays will likely cause non-optimal acidization. One possible response is to increase the acid injection rate by a factor ranging from 10 to 100 (1810) (depending on the numerically-predicted breakthrough curve as shown in FIG. 3) and to watch for the arrival of a “new” conductivity peak (1820). The operator may pump diversion fluid, add retardant to the acid to modify (i.e., reduce) reactivity or diffusivity, or direct the injected fluid to specific target intervals in the formation (1830). If the increased flow rate is such that the new conductivity peak is detected within the tolerance for ΔTₚₑₐₖ, operations can continue (1840) as shown in FIG. 16 and described in the accompanying text. If the increased injection rate is too high, causing an early conductivity peak to be detected, the operator may modify operations as shown in FIG. 17 and described in the accompanying text.

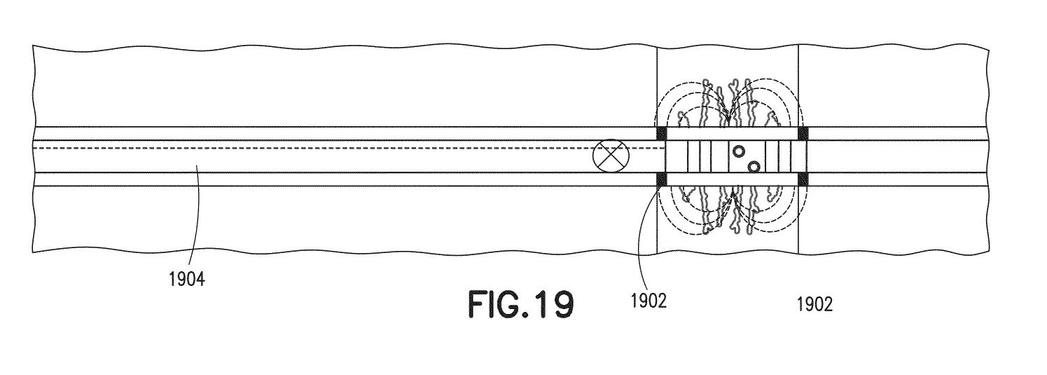

In a further embodiment, shown in FIG. 19, a high acid injection rate, in conjunction with a limited acid volume, is used to produce an early conductivity peak. The limited acid volume can be delivered to the formation by trapping the acid between two moveable plugs 1902 inside the coil tubing 1904 and pushing the combination downhole by injecting an additional non-acid fluid (e.g., brine). Having detected an early conductivity peak, the operator can continue the acidization operation by proceeding with operations as shown in FIG. 17 and described in the accompanying text.

An operator can also use the injection profile in combination with “diverting” stages of treatment. The diversion stages act to bridge off at the wellbore wall, thereby diverting the reactive acid stage to other segments of the borehole. The utilization of the distributed temperature measurement and DFLO measurements to compute an injection profile, and the array electrical measurements, allows one to estimate the type and depth of wormhole stimulation.

In a further embodiment, the complete wellbore can be sealed with a degradable material (e.g., polymeric or other viscous fluid, or a solid or fiber suspension) prior to acid injection. Based upon model predictions, a selected interval of the seal can be removed by displacing a metered volume of fluid that accelerates the degradation of the sealing material. Non-limiting examples include heated water, solvents, alcohols, and surfactants that dissolve or otherwise accelerate local degradation of the plugging/sealing materials. The acid injection is then directed to the target zone(s) in the well. Once stimulated, a second diversion slug may be injected to plug off the recently stimulated interval, the plugging material selectively removed from a second interval, and the process repeated.

After acid stimulation, well productivity depends on the number, length, diameter, and distribution of wormholes along the wellbore. The morphology of the wormholes is controlled by the reaction kinetics, acid injection rate, rock lithology, and formation heterogeneity. Recall, FIG. 3 illustrates the evolution of the wormhole morphology as a function of the injection rate. As the rate increases, the dissolution pattern transforms from face dissolution (no wormholes), to conical wormhole, to dominant wormhole, to ramified wormhole, and then to uniform dissolution. An optimal injection rate (producing dominant wormholes) is targeted when designing matrix acidizing because it results in the deepest wormholes with the minimal amount of acid. Using logging tools to conduct real-time measurements while acidizing can assist in determining the wormhole propagation mode and thereby take action to control the rate for successful acidizing.

In an embodiment, a neutron porosity tool tracks the dynamic porosity change of the formation while acidizing and can be used to assist the acid stimulation operation. As described above, a two-scale continuum model may be used to simulate the acid reactive formation, and this may be combined with calibration curves that convert the measured near-to-far detector counting rate ratio from the neutron logging tool into porosity. The measurements may indicate the type of acidizing regime that is occurring during the acidization operation and can be used to estimate the depth and speed of wormhole penetration.

In-situ, real-time downhole measurements of a (carbonate) formation undergoing acidization operations may be performed using a neutron (porosity) logging tool. The tool is disposed in the borehole and used to detect the change in the hydrogen content in the formation (resulting from the acid reactive dissolution) through the ratio of the near-to-far detector count rate of low-energy neutrons. Changes and trends of variations of this count rate ratio can be interpreted to track the penetration of wormholes and to detect the treatment zones where the acidization may not be progressing in accordance with expectations.

Neutron logging tools allow one to infer porosity because of their large sensitivity to hydrogen. Neutron logging tools have a source of neutron radiation, which is usually a chemical source but can also be a non-radioactive pulse neutron generator (PNG). The tools also have one or more detectors that measure the neutrons scattered back from the formation. Emitted neutrons encounter nuclei in the formation and borehole and undergo various interactions such as elastic scattering and thermal absorption.

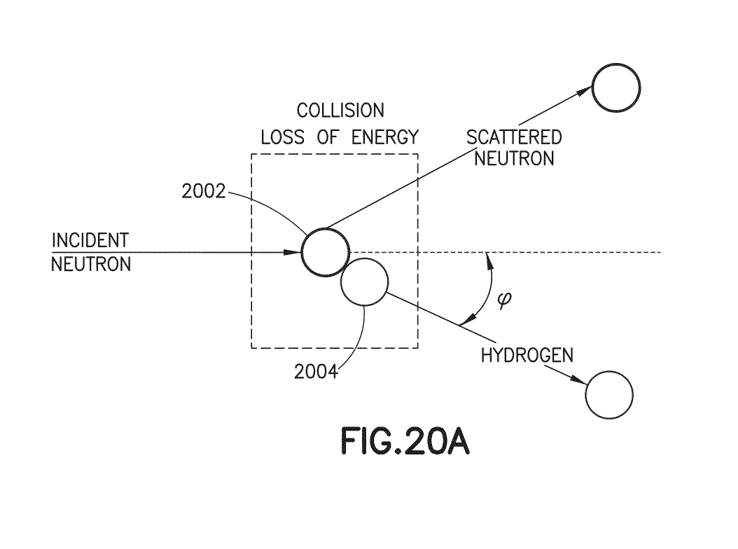

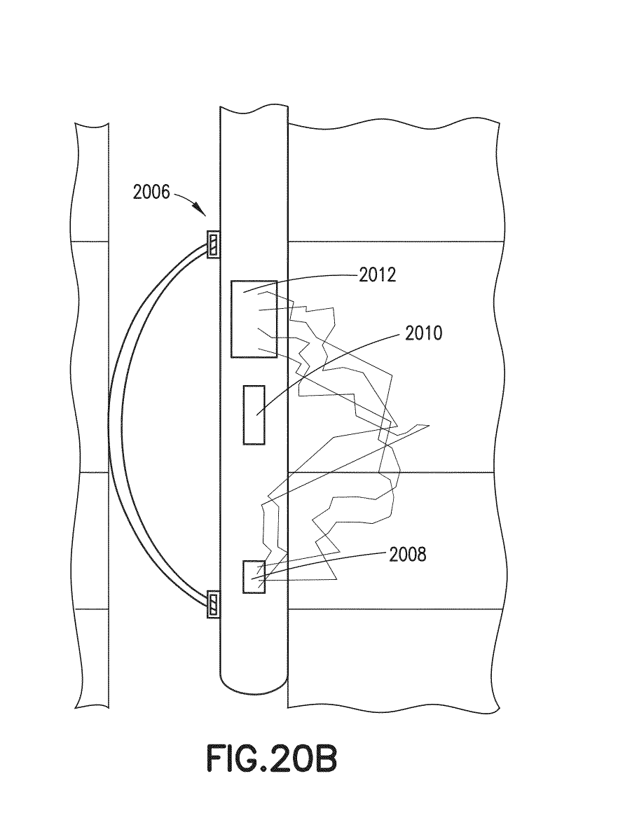

Elastic scattering constitutes the primary mechanism in which neutrons 2002 collide with isotopes 2004 (e.g., hydrogen) in such a way that the energy and momentum of the system are conserved (see FIG. 20A). With each collision, a neutron's kinetic energy is reduced as it travels away from the source region. The most efficient element to provide this energy reduction leading to detectable neutrons is hydrogen because of its mass being very close to that of the neutron. From conservation of energy and momentum, the maximum energy loss due to neutron-atomic nucleus collision is given by:

$$E = {( \frac{A - 1}{A + 1} )}^{2} {E}_{0} = α {E}_{0} \qquad ( 7 )$$

where E₀ and E are the neutron energies before and after collision, respectively, and A is the mass of the neutron relative to that of the encountered isotope. For hydrogen, α is approximately zero, implying a 180° scattering angle wherein a large fraction of neutron momentum is transferred to the proton. This element is unique in its ability to reduce the colliding energy to “zero” in a single collision (in practice, from several MeV to about 0.4 eV, depending on the scattering angle) and thereby produce detectable neutrons. Hydrogen is present in the formations in the form of hydrocarbons, water, or acid (when the formation is undergoing acidization) that fills the pore space. This provides a correlation between the formation porosity and the neutron scattering.

Neutron logging tools 2006 comprise a source 2008 to emit neutrons at high energy (on the order of a few MeV) and near- and far-spacing detectors (2010, 2012, respectively) that are most sensitive to low-energy neutrons. FIG. 20B shows thermal neutron logging tool 2006. The ratio of the near-to-far detector counting rate indicates the level of hydrogen content in the formation and is used to calculate the porosity. When the amount of hydrogen present in the formation is high, the very low-energy neutrons accumulate in the zone near the source and the counting rate of the near detector is greater than that of the far detector. In the case of a formation with low hydrogen content (low porosity), the distribution of neutrons is spread out and the ratio of the near-to-far counting rate is close to one.

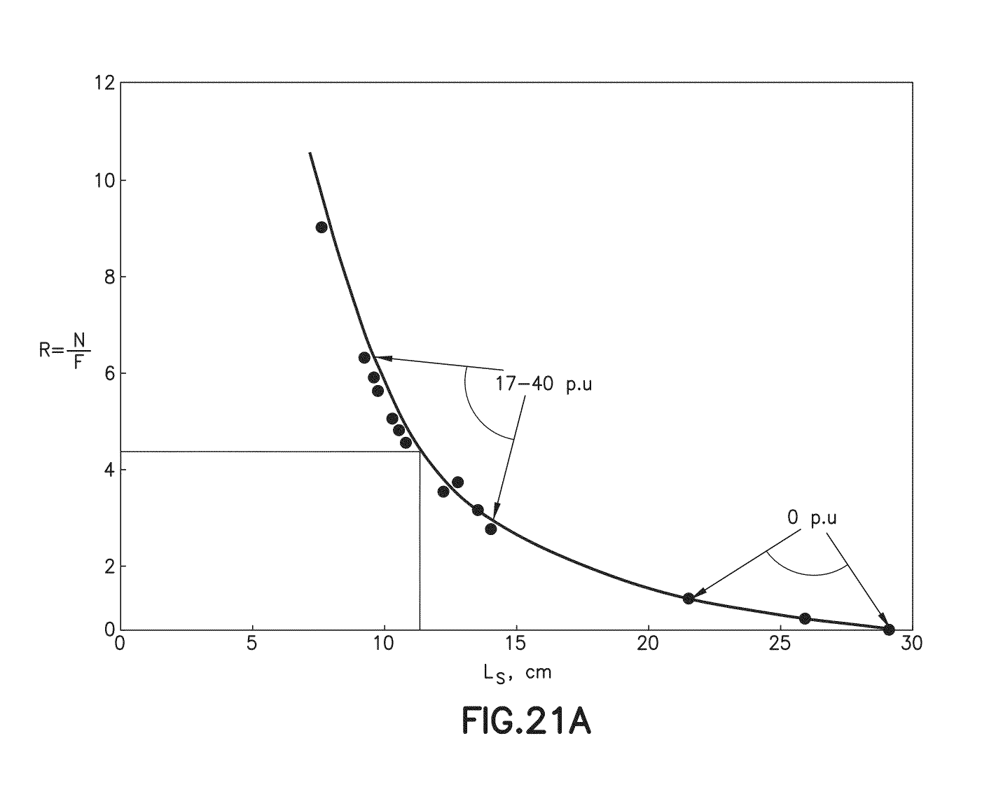

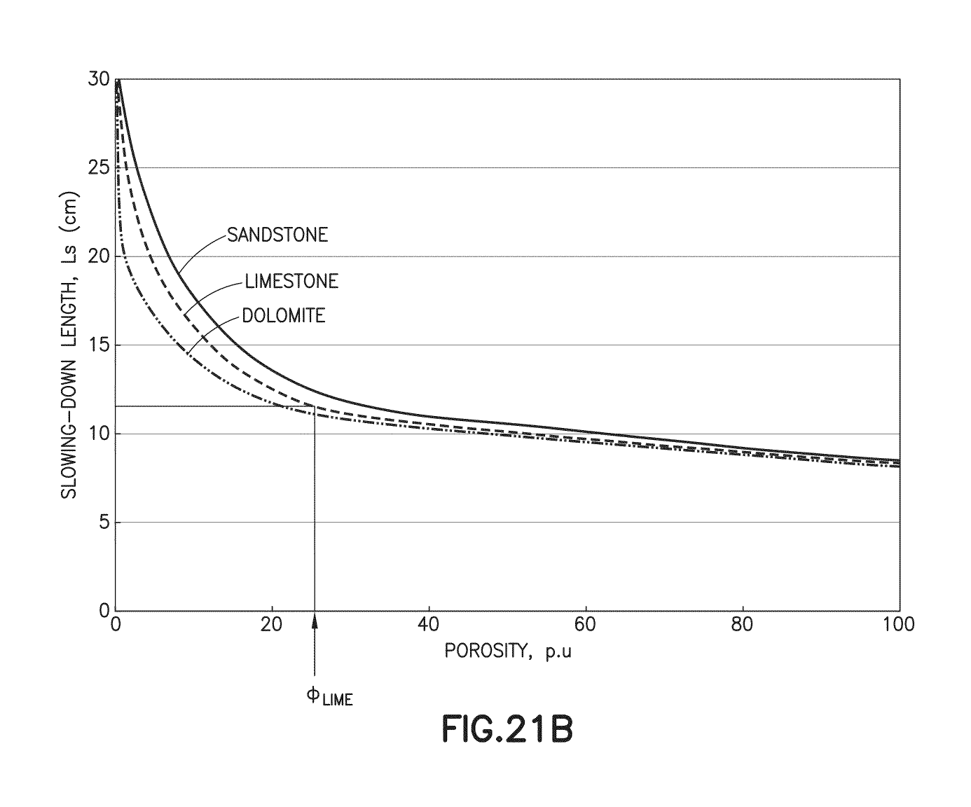

A parameter that controls the near-to-far detector count rate ratio of the neutron porosity tool is the formation “slowing-down length” Lₛ. Lₛ is proportional to the straight line distance that a neutron travels from the time it is emitted (from the source at high energy) to the time it attains a much lower energy. FIG. 21A is a calibration curve that enables the conversion of the measured ratio into a slowing-down length. FIG. 21B shows the variations of Lₛ with the water-filled porosity for three different rock types: dolomite, limestone, and sandstone. Making use of those two conversion curves, porosity can be extracted from the count rate ratio via the slowing-down length. Several formation and borehole properties such as pore fluid type, density, salinity, temperature, borehole size, and pressure may affect the reading of a neutron porosity device, and thus corrections are introduced to the calibration/conversion curves to account for those effects.

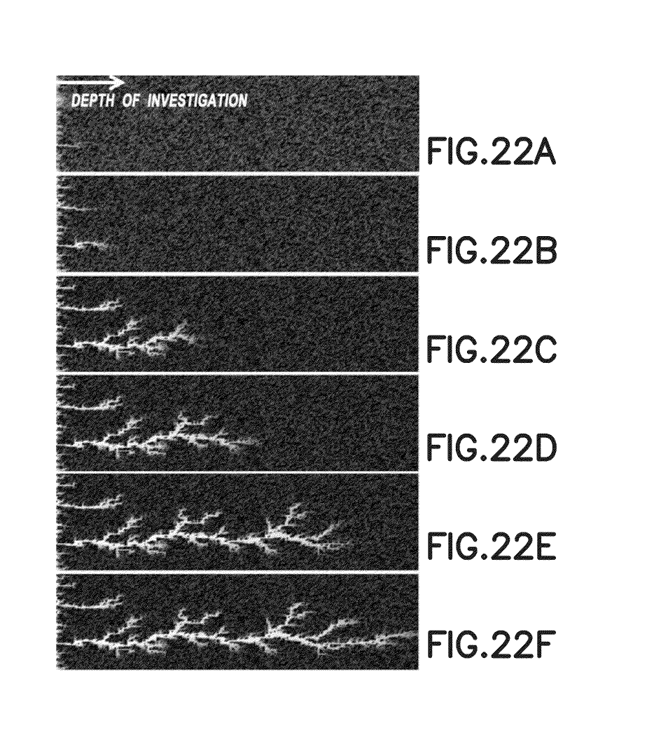

The carbonate acidizing model described above may be used to simulate the wormhole process and show how measurements retrieved from neutron logging tools can correlate with the dynamic change of porosity resulting from wormhole creation and propagation in carbonate rocks. Simulation results showing snapshots of the wormhole formation and propagation resulting from the reactive dissolution process obtained at different stages of injecting acid from the inlet face are illustrated in the time sequence of FIGS. 22A-22F. Several thin wormholes form at the inlet face, while a few of them penetrate deep into the carbonate.

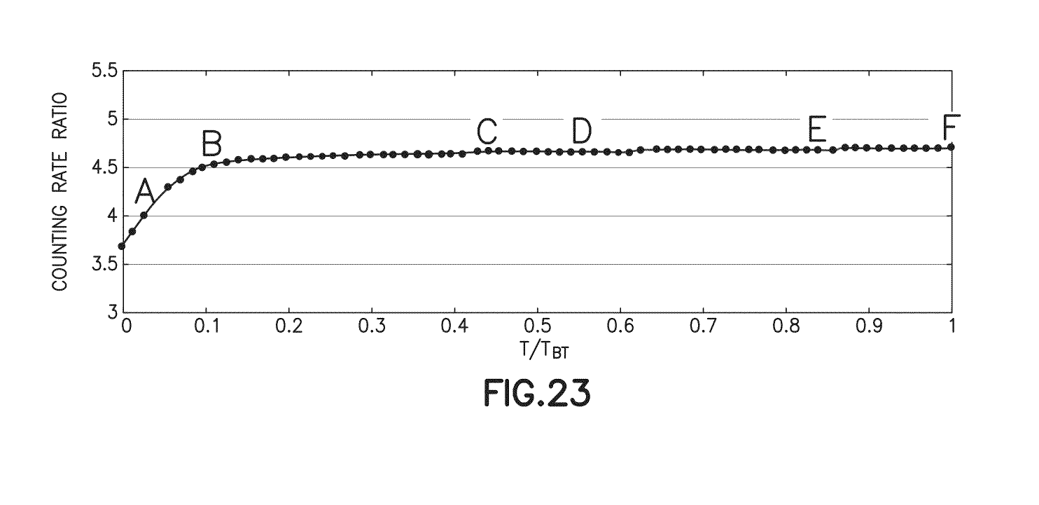

The transient variations in the near-to-far detector counting ratio as derived from a neutron logging tool are plotted in FIG. 23. The time scale is normalized by the time-to-breakthrough T_{BT} (i.e., time it took for the wormholes to reach the opposite end of the simulated rectangular core). These results were obtained by taking the dynamic change in the porosity, predicted from the numerical acidizing model, in combination with the conversion curves presented in FIG. 21A and 21B, to calculate count rates. An initial increase in the count rate ratio was observed as acid dissolved the rock matrix, followed by stabilization at a steady-state value at longer times (30% increase with respect to the pre-stimulation counting rate ratio). The initial increase is expected since the solid matrix, with relatively low hydrogen content, is being replaced with water-based fluid having a higher hydrogen level. The transient changes in the count rate ratio demonstrate the sensitivity of the neutron porosity tool to wormhole formation and propagation (porosity changes). Stabilization in the count rate ratio at longer times indicate that the wormholes have penetrated past the depth of investigation of the logging tool and any new porosity increase is happening at depths that are beyond the DOI of the tool. Points on the curve of FIG. 23 that correlate, respectively, to each of the wormhole stages of FIGS. 22A-22F are indicated in FIG. 23.

In a typical acidizing operation, the optimum acid injection rate is not known a priori and the operator may start with his best guess for acid injection rate. An expected response for the neutron logging tool similar to FIGS. 22A-22F and FIG. 23 can be calculated prior to acidization and the results of the tool measurement can be compared with these calculations in real time. A disagreement between the model result and actual tool reading implies the wrong choice of acid injection rate and this information can be used to adjust the acid injection rate. The neutron logging tool provides a relatively shallow depth of investigation compared to, say, a resistivity tool. Since most of the tool sensitivity lies in a region within a few inches of the borehole, this tool may be more sensitive to the initial/early events. Knowledge of such early events can lead one to adjust the acid injection rate before a large volume of acid has been used inefficiently.

Specific embodiments using particular logging tools have been described in detail above. Other logging tools can be used. For example, a dielectric logging tool or a gamma ray logging tool may also be used. Dielectric logging tools produce a log of the high-frequency (e.g., on the order of 25 MHz) dielectric properties of the formation. The log includes two curves: the relative dielectric permittivity and the resistivity. A gamma ray logging tool produces a log of the total natural radioactivity. The depth of investigation is generally a few inches, so that the log normally measures the flushed zone. Shales and clays are responsible for most natural radioactivity, so the gamma ray log often is a good indicator of such rocks. However, other rocks are also radioactive, notably some carbonates and feldspar-rich rocks. Without repeating details described above, these and other logging tools may be incorporated into alternative embodiments in which their respective measurement or inference of a formation property is used to monitor matrix acidizing operations.

Some of the methods and processes described above, including processes, as listed above, can be performed by a processor. The term “processor” should not be construed to limit the embodiments disclosed herein to any particular device type or system. The processor may include a computer system. The computer system may also include a computer processor (e.g., a microprocessor, microcontroller, digital signal processor, or general purpose computer) for executing any of the methods and processes described above.

The computer system may further include a memory such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device.

Some of the methods and processes described above, as listed above, can be implemented as computer program logic for use with the computer processor. The computer program logic may be embodied in various forms, including a source code form or a computer executable form. Source code may include a series of computer program instructions in a variety of programming languages (e.g., an object code, an assembly language, or a high-level language such as C, C++, or JAVA). Such computer instructions can be stored in a non-transitory computer readable medium (e.g., memory) and executed by the computer processor. The computer instructions may be distributed in any form as a removable storage medium with accompanying printed or electronic documentation (e.g., shrink wrapped software), preloaded with a computer system (e.g., on system ROM or fixed disk), or distributed from a server or electronic bulletin board over a communication system (e.g., the Internet or World Wide Web).

Alternatively or additionally, the processor may include discrete electronic components coupled to a printed circuit board, integrated circuitry (e.g., Application Specific Integrated Circuits (ASIC)), and/or programmable logic devices (e.g., a Field Programmable Gate Arrays (FPGA)). Any of the methods and processes described above can be implemented using such logic devices.

While the embodiments described above particularly pertain to the oil and gas industry, this disclosure also contemplates and includes potential applications such as CO₂ storage, underground water detection, geology, monitoring of water content (e.g., swage or landfill leak), environmental spill monitoring, and wherever a long-term monitoring tool for water- or oil-bearing material is required.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the scope of the present disclosure, and that they may make various changes, substitutions, and alterations herein without departing from the scope of the present disclosure.

The Abstract at the end of this disclosure is provided to comply with 37 C.F.R. §1.72(b) to allow the reader to quickly ascertain the nature of the technical disclosure. It is submitted with the understanding that it will not be used to interpret or limit the scope or meaning of the claims.

While only certain embodiments have been set forth, alternatives and modifications will be apparent from the above description to those skilled in the art. These and other alternatives are considered equivalents and within the scope of this disclosure and the appended claims. Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method, comprising:
providing a logging tool and disposing the logging tool in a wellbore during an acidizing operation;
making measurements using the logging tool on a region of a formation penetrated by the wellbore and being subjected to the acidizing operation;
inferring one or more properties of the formation at one or more depths of investigation within the region using the measurements; and
making one or more acidizing operation management decisions based on the determined one or more inferred properties.

2. The method of claim 1, wherein the logging tool is selected from the group consisting of:
an acoustic tool, a resistivity tool, a dielectric tool, a gamma ray tool, and a neutron tool.

3. The method of claim 1, wherein the one or more inferred properties is selected from the group consisting of: acoustic velocity, conductivity peak observation time, near-to-far detector count ratio, water saturation, and porosity.

4. The method of claim 1, wherein the making one or more acidizing operation management decisions comprises:
maintaining an acid injection rate, increasing the acid injection rate, or decreasing the acid injection rate.

5. A method, comprising:
providing a logging tool and disposing the logging tool in a wellbore during an acidizing operation;
making measurements using the logging tool on a region of a formation penetrated by the wellbore and being subjected to the acidizing operation;
inferring one or more properties of the formation at one or more depths of investigation within the region using the measurements;
simulating at least one of the one or more inferred properties;
determining a minimized difference or differences between the one or more inferred formation properties and the corresponding simulated formation property or properties; and
making one or more acidizing operation management decisions based on the determined minimized difference or differences.

6. The method of claim 5, wherein the simulating comprises using a two-scale model.

7. The method of claim 6, wherein the two-scale model comprises a Darcy scale model and a pore-scale model.

8. The method of claim 6, wherein the two-scale model uses discretized blocks and, for each discretized block, determines one or more properties selected from the group consisting of: the dynamic evolution of the porosity, a time-dependent acid concentration, the pressure, and the fluid velocity.

9. A method, comprising:
providing an acoustic logging tool and disposing the acoustic logging tool in a wellbore during an acidizing operation;
making measurements using the acoustic logging tool on a region of a formation penetrated by the wellbore and being subjected to the acidizing operation;
inferring one or more properties of the formation at one or more depths of investigation within the region using the measurements;
simulating at least one of the one or more inferred properties;
determining a minimized difference or differences between the one or more inferred formation properties and the corresponding simulated formation property or properties; and
making one or more acidizing operation management decisions based on the determined minimized difference or differences.

10. The method of claim 9, wherein the making measurements comprises measuring and recording interval transit times for an acoustic wave.

11. The method of claim 9, wherein the one or more inferred properties is selected from the group consisting of acoustic velocity and porosity.

12. The method of claim 9, wherein the making one or more acidizing operation management decisions comprises maintaining an acid injection rate, increasing the acid injection rate, or decreasing the acid injection rate.

13. The method of claim 9, wherein the simulating comprises using a two-scale model.

14. The method of claim 13, wherein the two-scale model comprises a Darcy scale model and a pore-scale model.

15. The method of claim 13, wherein the two-scale model uses discretized blocks and, for each discretized block, determines one or more properties selected from the group consisting of the dynamic evolution of the porosity, a time-dependent acid concentration, the pressure, and the fluid velocity.

16. A method, comprising:
providing a resistivity logging tool and disposing the resistivity logging tool in a wellbore during an acidizing operation;
making measurements using the resistivity logging tool on a region of a formation penetrated by the wellbore and being subjected to the acidizing operation;
inferring one or more properties of the formation at one or more depths of investigation within the region using the measurements;
simulating at least one of the one or more inferred properties;
determining a minimized difference or differences between the one or more inferred formation properties and the corresponding simulated formation property or properties; and
making one or more acidizing operation management decisions based on the determined minimized difference or differences.

17. The method of claim 16, wherein the making measurements comprises measuring voltages and determining resistivities based on the measured voltages.

18. The method of claim 16, wherein the one or more inferred properties is selected from the group consisting of conductivity and conductivity peak time.

19. The method of claim 16, wherein the making one or more acidizing operation management decisions comprises maintaining an acid injection rate, increasing the acid injection rate, or decreasing the acid injection rate.

20. The method of claim 16, wherein the simulating comprises using a two-scale model.

21. The method of claim 20, wherein the two-scale model comprises a Darcy scale model and a pore-scale model.

22. The method of claim 20, wherein the two-scale model uses discretized blocks and, for each discretized block, determines one or more properties selected from the group consisting of the dynamic evolution of the porosity, a time-dependent acid concentration, the pressure, and the fluid velocity.

23. A method, comprising:
providing a neutron logging tool and disposing the neutron logging tool in a wellbore during an acidizing operation;
making measurements using the neutron logging tool on a region of a formation penetrated by the wellbore and being subjected to the acidizing operation;
inferring one or more properties of the formation at one or more depths of investigation within the region using the measurements;
simulating at least one of the one or more inferred properties;
determining a minimized difference or differences between the one or more inferred formation properties and the corresponding simulated formation property or properties; and
making one or more acidizing operation management decisions based on the determined minimized difference or differences.

24. The method of claim 23, wherein the making measurements comprises measuring neutron counts at two or more spaced-apart detectors.

25. The method of claim 23, wherein the one or more inferred properties is selected from the group consisting of a near-to-far detector count rate ratio, a slowing-down length, and porosity.

26. The method of claim 23, wherein the making one or more acidizing operation management decisions comprises maintaining an acid injection rate, increasing the acid injection rate, or decreasing the acid injection rate.

27. The method of claim 23, wherein the simulating comprises using a two-scale model.

28. The method of claim 27, wherein the two-scale model comprises a Darcy scale model and a pore-scale model.

29. The method of claim 27, wherein the two-scale model uses discretized blocks and, for each discretized block, determines one or more properties selected from the group consisting of the dynamic evolution of the porosity, a time-dependent acid concentration, the pressure, and the fluid velocity.

30. A system, comprising:
a logging tool disposed in a wellbore during an acidizing operation; and
a processor carried on the logging tool capable of:
making measurements using the logging tool on a region of a formation penetrated by the wellbore and being subjected to the acidizing operation;
inferring one or more properties of the formation at one or more depths of investigation within the region using the measurements; and
making one or more acidizing operation management decisions based on the one or more inferred formation properties.

31. The system of claim 30, wherein the logging tool is selected from the group consisting of an acoustic tool, a resistivity tool, a dielectric tool, a gamma ray tool, and a neutron tool.

32. The system of claim 30, wherein the processor is further capable of:
simulating at least one of the one or more inferred properties; and
determining a minimized difference or differences between the one or more inferred formation properties and the corresponding simulated formation property or properties; and wherein the making one or more acidizing operation management decisions is further based on the determined minimized difference or differences.
